(19) United States
(12) Patent Application Publication
(10) Pub. No.: US 2026/0019880 A1
(43) Pub. Date: Jan. 15, 2026

(54) COMMUNICATION METHOD AND APPARATUS

(71) Applicant: HUAWEI TECHNOLOGIES CO., LTD., Shenzhen (CN)

(72) Inventors: Yurong Song, Beijing (CN); Fei Liu, Singapore (SG); Donghui Wang, Beijing (CN)

(21) Appl. No.: 19/335,101

(22) Filed: Sep. 22, 2025

Related U.S. Application Data
(63) Continuation of application No. PCT/CN2023/083523, filed on Mar. 23, 2023.

(51) Int. Cl. H04W 28/18; H04W 12/00; H04W 28/02

(52) U.S. Cl. CPC H04W 28/18; H04W 28/0215; H04W 12/00

(57) ABSTRACT

This application discloses a communication method and apparatus. The method includes: A fourth entity sends first information to a first entity, where the first information is used to determine first configuration information of the first entity, and the first configuration information is configuration information used by the first entity to provide a security capability for a third entity. The first entity sends first feedback information, where the first feedback information indicates whether the first entity is successfully configured with the first configuration information. According to the method, the fourth entity can configure the first entity based on the first information, so that the first entity can be configured quickly and flexibly.

### CROSS-REFERENCE TO RELATED APPLICATIONS

This application is a continuation International Application No. PCT/CN2023/083523, filed on Mar. 23, 2023, the disclosure of which is hereby incorporated by reference in its entirety.

### TECHNICAL FIELD

This application relates to the field of communication technologies, and in particular, to a communication method and apparatus.

### BACKGROUND

To improve communication security, a communication apparatus may correspond to a security function, and the security function may provide a security capability for the corresponding communication apparatus. Currently, in a mobile communication network, a security function of a communication apparatus is fixed. The security function node corresponding to the communication apparatus changes, for example, a security function is added, updated, or deleted, only when the communication apparatus is updated and the network is upgraded. In this case, the security function cannot flexibly adapt to an actual application scenario and a security requirement of the communication apparatus.

In addition, the security function is tightly coupled to a communication function of the communication apparatus, and management of the communication function of the communication apparatus is delivered by a management plane. For example, an operator sets up, updates, or deletes the communication function of the communication apparatus through an operation, administration, and maintenance (OAM) device. Therefore, the communication function of the communication apparatus cannot be flexibly configured, and consequently, the security function of the communication apparatus cannot be flexibly configured either.

### SUMMARY

This application provides a communication method and apparatus, to flexibly configure a security function of the communication apparatus.

According to a first aspect, an embodiment of this application provides a communication method. The method includes: A first entity receives first information. The first information may be used to determine first configuration information of the first entity, and the first configuration information is configuration information used by the first entity to provide a security capability for a third entity. The first entity may then send first feedback information, where the first feedback information indicates whether the first entity is successfully configured with the first configuration information.

According to the method, the first information received by the first entity can be used to configure the first entity, so that the first entity can be configured quickly and flexibly. The first information is, for example, sent by a fourth entity to the first entity. The fourth entity may configure the first entity by using signaling. Therefore, when the fourth entity perceives a change in an application scenario, the fourth entity may configure the first entity in time, so that the configuration of the first entity can meet a current requirement, and reliable security support is provided for the third entity. In addition, in a possible implementation, the first entity may be an entity independent of the third entity, the first entity may serve as a security function, and the third entity may serve as a communication function, so that the security function independent of the communication function can be flexibly configured, thereby facilitating independent evolution, update, and upgrade of the security function.

In a possible implementation, the fourth entity may be the third entity, and the third entity, as a security capability demander, may trigger the configuration of the first entity. This improves a capability of the third entity to control the first entity serving as a security function, so that the first entity can provide a security service for the third entity as required.

In a possible design, the first information may be used to determine the first configuration information in one of the following implementations.

Implementation 1: The first information may indicate a first parameter used to perform a management operation on the first entity, and the first parameter is used to determine the first configuration information.

Through Implementation 1, the first entity may receive the first parameter, and the first entity does not need to obtain the first parameter by analyzing a security policy or a security requirement, so that a calculation loss of the first entity can be reduced, and computing resources and power of the first entity can be saved.

Implementation 2: The first information indicates a security policy of at least one entity, the at least one entity includes the third entity, and the security policy is used to determine the first configuration information. The first information may be sent by the second entity to the first entity.

Optionally, the security policy may include a security capability that the at least one entity needs to have and/or a security capability that the at least one entity does not need to have.

In a possible implementation, the security policy may be used to determine a first parameter used to perform a management operation on the first entity, and the first parameter is used to determine the first configuration information.

Through Implementation 2, the second entity may send the security policy to the first entity serving as a security function, and the first entity determines the first configuration information of the first entity based on the security policy. In this way, the second entity does not need to determine, for each security function, a parameter used to perform the management operation, so that efficiency of configuring the security function by the second entity can be improved, a calculation loss of the second entity can be reduced, and computing resources and power of the second entity can be saved.

Implementation 3: The first information indicates a security requirement of the third entity, and the security requirement is used to determine the first configuration information. The first information may be sent by the third entity to the first entity.

Optionally, the security requirement includes a security capability that the third entity needs to have and/or a security capability that the third entity does not need to have.

In a possible implementation, the security requirement may be used to determine a first parameter used to perform a management operation on the first entity, and the first parameter is used to determine the first configuration information.

Through Implementation 3, the third entity may send the security requirement to the first entity serving as a security function, and the first entity determines the first configuration information of the first entity based on the security requirement. In this way, the third entity does not need to analyze the security requirement, so that a calculation loss of the third entity can be reduced, and computing resources and power of the third entity can be saved.

In a possible design, in Implementation 1 to Implementation 3 above, the management operation may include one of the following: a setup operation, an update operation, a lock operation, an unlock operation, or a delete operation. According to this design, a plurality of operations can be flexibly performed on the entity, so that the configuration of the first entity can meet a current requirement, and reliable security support is provided for the third entity.

In a possible design, in Implementation 1 to Implementation 3 above, the first parameter may include at least one of the following: a type of the management operation performed on the first entity; a first state, where the first state includes an expected state of the first entity and/or an expected state of a security capability module that is in the first entity and on which the management operation is to be performed; indication information of a security capability module that is in the first entity and on which the management operation is to be performed; or indication information of an algorithm that is in a security capability module of the first entity and on which the management operation is to be performed. According to this design, the first entity can accurately and quickly perform a responded corresponding management operation based on the first parameter, so that the configuration of the first entity can meet a current requirement, and reliable security support is provided for the third entity.

In a possible design, the first feedback information further includes the first configuration information. For example, in Implementation 1 and Implementation 2 above, if the first entity receives the first information from the second entity, and the second entity is an entity that manages the first entity, the first feedback information further includes the first configuration information. In this way, the second entity can obtain and store the first configuration information, to effectively manage the first entity.

Implementation 4: The first information includes the first configuration information. The first information may be sent by the second entity to the first entity.

Through Implementation 4, the first entity may obtain the first configuration information from the second entity, and the first entity does not need to obtain the first configuration information by analyzing a security policy or a security requirement, so that a calculation loss of the first entity can be reduced, and computing resources and power of the first entity can be saved.

In a possible design, if the first entity receives the first information from the second entity, and the second entity is an entity that manages the first entity, the first entity may further send second information to the third entity, where the second information indicates a first security capability provided by the first entity for the third entity, and the first security capability is determined based on the first information. According to this design, the first entity can notify the third entity in time of the first security capability that can be provided by the first entity, so that the third entity invokes the first entity to support the first security capability.

In a possible design, the first entity may further receive third information from the third entity, where the third information indicates whether the first security capability meets a requirement of the third entity. When the third information indicates that the first security capability meets the requirement of the third entity, the first feedback information may indicate that the first entity is successfully configured with the first configuration information. According to this design, the first entity can learn whether the first security capability meets the requirement of the third entity, so that the configuration of the first entity can be further adjusted based on the requirement of the third entity.

In a possible design, the second information includes indication information of the first security capability and identification information of the first entity. According to this design, the first entity can accurately notify the third entity of the first security capability of the first entity.

In a possible design, if the first entity receives the first information from the third entity, the first entity may further send fourth information to a second entity, where the fourth information includes the first configuration information, the fourth information is used to register the first configuration information of the first entity, and the second entity is an entity that manages the first entity. According to this design, the second entity can obtain the first configuration information, to effectively manage the first entity.

In a possible design, the first entity may receive fifth information from the second entity, where the fifth information indicates whether the first configuration information of the first entity is successfully registered. When the fifth information indicates that the first configuration information of the first entity is successfully registered, the first feedback information may indicate that the first entity is successfully configured with the first configuration information. According to this design, the first entity can learn in time whether the first configuration information is successfully registered, to provide, for the third entity based on a registration result, a security capability allowed by the second entity.

According to a second aspect, an embodiment of this application provides a communication method. The method includes: A fourth entity sends first information. The first information is used to determine first configuration information of a first entity, the first configuration information is configuration information used by the first entity to provide a security capability for a third entity, and the fourth entity is the third entity or a second entity that manages the first entity. The fourth entity may then receive first feedback information, where the first feedback information indicates whether the first entity is successfully configured with the first configuration information.

According to the method, the fourth entity can configure the first entity based on the first information, so that the first entity can be configured quickly and flexibly. The fourth entity may configure the first entity by using signaling. Therefore, when the fourth entity perceives a change in an application scenario, the fourth entity may configure the first entity in time, so that the configuration of the first entity can meet a current requirement, and reliable security support is provided for the third entity. In addition, in the method, the first entity may be an entity independent of the third entity, the first entity may serve as a security function, and the third entity may serve as a communication function, so that the security function independent of the communication function can be flexibly configured, thereby facilitating independent evolution, update, and upgrade of the security function.

In addition, in the method, the fourth entity may be the third entity, and the third entity, as a security capability demander, may trigger the configuration of the first entity. This improves a capability of the third entity to control the first entity serving as a security function, so that the first entity can provide a security service for the third entity as required.

In a possible design, the first information may be used to determine the first configuration information in one of the following implementations.

Implementation 1: The first information indicates a first parameter used to perform a management operation on the first entity, and the first parameter is used to determine the first configuration information.

Through Implementation 1, the fourth entity may send the first parameter to the first entity, and the first entity does not need to obtain the first parameter by analyzing a security policy or a security requirement, so that a calculation loss of the first entity can be reduced, and computing resources and power of the first entity can be saved.

Implementation 2: The first information indicates a security policy of at least one entity, the at least one entity includes the third entity, and the security policy is used to determine the first configuration information. The first information may be sent by the second entity to the first entity.

Optionally, the security policy includes a security capability that the at least one entity needs to have and/or a security capability that the at least one entity does not need to have.

In a possible implementation, the security policy is used to determine a first parameter used to perform a management operation on the first entity, and the first parameter is used to determine the first configuration information.

Through Implementation 2, the second entity may send the security policy to the first entity serving as a security function, and the first entity determines the first configuration information of the first entity based on the security policy. In this way, the second entity does not need to determine, for each security function, a parameter used to perform the management operation, so that efficiency of configuring the security function by the second entity can be improved, a calculation loss of the second entity can be reduced, and computing resources and power of the second entity can be saved.

Implementation 3: The first information indicates a security requirement of the third entity, and the security requirement is used to determine the first configuration information. The first information may be sent by the third entity to the first entity.

Optionally, the security requirement includes a security capability that the third entity needs to have and/or a security capability that the third entity does not need to have.

In a possible implementation, the security requirement is used to determine a first parameter used to perform a management operation on the first entity, and the first parameter is used to determine the first configuration information.

Through Implementation 3, the third entity may send the security requirement to the first entity serving as a security function, and the first entity determines the first configuration information of the first entity based on the security requirement. In this way, the third entity does not need to analyze the security requirement, so that a calculation loss of the third entity can be reduced, and computing resources and power of the third entity can be saved.

In a possible design, in Implementation 1 to Implementation 3 above, the management operation includes one of the following: a setup operation, an update operation, a lock operation, an unlock operation, or a delete operation. According to this design, a plurality of operations can be flexibly performed on the entity, so that the configuration of the first entity can meet a current requirement, and reliable security support is provided for the third entity.

In a possible design, in Implementation 1 to Implementation 3 above, the first parameter includes at least one of the following: a type of the management operation performed on the first entity; a first state, where the first state includes an expected state of the first entity and/or an expected state of a security capability module that is in the first entity and on which the management operation is to be performed; indication information of a security capability module that is in the first entity and on which the management operation is to be performed; or indication information of an algorithm that is in a security capability module of the first entity and on which the management operation is to be performed. In this way, the first entity can accurately and quickly perform a corresponding management operation based on the first parameter, so that the configuration of the first entity can meet a current requirement, and reliable security support is provided for the third entity.

In a possible design, the first feedback information further includes the first configuration information. For example, in Implementation 1 and Implementation 2 above, if the first entity receives the first information from the second entity, and the second entity is an entity that manages the first entity, the first feedback information further includes the first configuration information. In this way, the second entity can obtain and store the first configuration information, to effectively manage the first entity.

Implementation 4: The first information includes the first configuration information. The first information may be sent by the second entity to the first entity.

Through Implementation 4, the second entity may send the first configuration information to the first entity, and the first entity does not need to obtain the first configuration information by analyzing a security policy or a security requirement, so that a calculation loss of the first entity can be reduced, and computing resources and power of the first entity can be saved.

In a possible design, the first entity may be set up through the following steps: After receiving request information from the third entity, the second entity sends second feedback information to the third entity. The request information is used to request to set up the first entity, and the second feedback information indicates information for setting up the first entity. The second entity may then receive sixth information from the first entity, where the sixth information includes first configuration information of the first entity, and the sixth information indicates whether the first entity is successfully configured with the first configuration information.

According to the method, when the first entity does not exist, the third entity may request the second entity to set up the first entity based on a requirement of the third entity, so that the first entity can be quickly and flexibly set up. In addition, the first entity may be set up by using signaling. Therefore, when the third entity perceives a change in an application scenario, the third entity may request the second entity in time to set up the first entity, so that the setup of the first entity meets a current requirement, and reliable security support is provided for the third entity. In addition, in the method, the third entity, as a security capability demander, may trigger the setup of the first entity. This improves a capability of the third entity to control the first entity serving as a security function, so that the first entity can provide a security service for the third entity as required. In addition, in the method, the first entity may be an entity independent of the third entity, the first entity may serve as a security function, and the third entity may serve as a communication function, so that the security function independent of the communication function can be flexibly set up, thereby facilitating independent evolution, update, and upgrade of the security function.

In a possible design, the second feedback information includes a download address of the first entity. According to this design, the third entity can quickly obtain content of the first entity, and the second feedback information includes a small amount of information, so that signaling overheads can be reduced.

In a possible design, the request information includes indication information of a security capability module in the first entity. According to this design, the content of the first entity can be accurately indicated, so that a speed of setting up the first entity can be increased.

In a possible design, the second entity may further send seventh information to the third entity, where the seventh information indicates a second security capability, and the second security capability is a security capability of the first entity. In this way, the second entity can notify the third entity in time of the second security capability that can be provided by the first entity, so that the third entity invokes the first entity to support the second security capability.

In a possible design, the seventh information includes indication information of the second security capability and identification information of the first entity. According to this design, the second entity can accurately notify the third entity of the second security capability of the first entity.

According to a third aspect, an embodiment of this application provides a communication method. The method includes: After receiving request information from a third entity, a second entity sends second feedback information to the third entity. The request information is used to request to set up a first entity, the first entity is an entity that provides a security capability for the third entity, and the second feedback information indicates information for setting up the first entity. The second entity may then receive sixth information from the first entity, where the sixth information includes first configuration information of the first entity, and the sixth information indicates whether the first entity is successfully configured with the first configuration information.

In a possible design, the second feedback information includes a download address of the first entity.

In a possible design, the request information includes indication information of a security capability module in the first entity.

In a possible design, the second entity may send seventh information to the third entity, where the seventh information indicates a second security capability, and the second security capability is a security capability of the first entity.

In a possible design, the seventh information includes indication information of the second security capability and identification information of the first entity.

According to a fourth aspect, an embodiment of this application provides a communication method. The method includes: A third entity sends request information to a second entity, where the request information is used to request to set up a first entity, and the first entity is an entity that provides a security capability for the third entity. The third entity may then receive second feedback information from the second entity, where the second feedback information indicates information for setting up the first entity; and set up the first entity based on the second feedback information.

In a possible design, the second feedback information includes a download address of the first entity.

In a possible design, the request information includes indication information of a security capability module in the first entity.

In a possible design, the third entity receives seventh information from the second entity, where the seventh information indicates a second security capability, and the second security capability is a security capability of the first entity.

In a possible design, the seventh information includes indication information of the second security capability and identification information of the first entity.

According to a fifth aspect, an embodiment of this application provides a communication apparatus. The communication apparatus may be configured to implement the communication method in the first aspect, that is, configured to perform an operation of the first entity in the method according to the first aspect. In a possible implementation, the communication apparatus may include one-to-one corresponding modules or units to perform the methods/operations/steps/actions described in the first aspect. The module or the unit may be a hardware circuit, may be software, or may be implemented by a hardware circuit in combination with software.

In a possible implementation, the apparatus includes a communication unit and a processing unit. The communication unit is configured to receive and/or send information. The processing unit is configured to: receive first information through the communication unit, where the first information is used to determine first configuration information of the communication apparatus, and the first configuration information is configuration information used by the communication apparatus to provide a security capability for a third entity; and send first feedback information through the communication unit, where the first feedback information indicates whether the communication apparatus is successfully configured with the first configuration information.

In Implementation 1, the first information indicates a first parameter used to perform a management operation on the communication apparatus, and the first parameter is used to determine the first configuration information.

In Implementation 2, the first information indicates a security policy of at least one entity, the at least one entity includes the third entity, and the security policy is used to determine the first configuration information.

Optionally, the security policy includes a security capability that the at least one entity needs to have and/or a security capability that the at least one entity does not need to have.

In a possible implementation, the security policy is used to determine a first parameter used to perform a management operation on the communication apparatus, and the first parameter is used to determine the first configuration information.

In Implementation 3, the first information indicates a security requirement of the third entity, and the security requirement is used to determine the first configuration information.

Optionally, the security requirement includes a security capability that the third entity needs to have and/or a security capability that the third entity does not need to have.

In a possible implementation, the security requirement is used to determine a first parameter used to perform a management operation on the communication apparatus, and the first parameter is used to determine the first configuration information.

In a possible design, in Implementation 1 to Implementation 3, the management operation includes one of the following: a setup operation, an update operation, a lock operation, an unlock operation, or a delete operation.

In a possible design, in Implementation 1 to Implementation 3, the first parameter includes at least one of the following: a type of the management operation performed on the communication apparatus; a first state, where the first state includes an expected state of the communication apparatus and/or an expected state of a security capability module that is in the communication apparatus and on which the management operation is to be performed; indication information of a security capability module that is in the communication apparatus and on which the management operation is to be performed; or indication information of an algorithm that is in a security capability module of the communication apparatus and on which the management operation is to be performed.

In a possible design, in Implementation 1 and Implementation 2, the first feedback information further includes the first configuration information.

In Implementation 4, the first information includes the first configuration information.

In a possible design, the processing unit is further configured to: receive first information from a second entity through the communication unit, where the second entity is an entity that manages the communication apparatus; and send second information to the third entity through the communication unit, where the second information indicates a first security capability provided by the communication apparatus for the third entity, and the first security capability is determined based on the first information.

In a possible design, the processing unit is further configured to receive third information from the third entity through the communication unit, where the third information indicates whether the first security capability meets a requirement of the third entity. When the third information indicates that the first security capability meets the requirement of the third entity, the first feedback information indicates that the communication apparatus is successfully configured with the first configuration information.

Optionally, the second information includes indication information of the first security capability and identification information of the communication apparatus.

In a possible design, the processing unit is further configured to: receive first information from the third entity through the communication unit; and send fourth information to a second entity through the communication unit, where the fourth information includes the first configuration information, the fourth information is used to register the first configuration information of the communication apparatus, and the second entity is an entity that manages the communication apparatus.

In a possible design, the processing unit is further configured to receive fifth information from the second entity through the communication unit, where the fifth information indicates whether the first configuration information of the communication apparatus is successfully registered. When the fifth information indicates that the first configuration information of the communication apparatus is successfully registered, the first feedback information indicates that the communication apparatus is successfully configured with the first configuration information.

According to a sixth aspect, an embodiment of this application provides a communication apparatus. The communication apparatus may be configured to implement the communication method in the second aspect, that is, configured to perform an operation of the fourth entity in the method according to the second aspect. In a possible implementation, the communication apparatus may include one-to-one corresponding modules or units to perform the methods/operations/steps/actions described in the second aspect. The module or the unit may be a hardware circuit, may be software, or may be implemented by a hardware circuit in combination with software.

In a possible implementation, the apparatus includes a communication unit and a processing unit. The communication unit is configured to receive and/or send information. The processing unit is configured to: send first information through the communication unit, where the first information is used to determine first configuration information of a first entity, the first configuration information is configuration information used by the first entity to provide a security capability for a third entity, and the communication apparatus is a third entity or a second entity that manages the first entity; and receive first feedback information through the communication unit, where the first feedback information indicates whether the first entity is successfully configured with the first configuration information.

In Implementation 1, the first information indicates a first parameter used to perform a management operation on the first entity, and the first parameter is used to determine the first configuration information.

In Implementation 2, the first information indicates a security policy of at least one entity, the at least one entity includes the third entity, and the security policy is used to determine the first configuration information.

Optionally, the security policy includes a security capability that the at least one entity needs to have and/or a security capability that the at least one entity does not need to have.

In a possible implementation, the security policy is used to determine a first parameter used to perform a management operation on the first entity, and the first parameter is used to determine the first configuration information.

In Implementation 3, the first information indicates a security requirement of the third entity, and the security requirement is used to determine the first configuration information.

Optionally, the security requirement includes a security capability that the third entity needs to have and/or a security capability that the third entity does not need to have.

In a possible implementation, the security requirement is used to determine a first parameter used to perform a management operation on the first entity, and the first parameter is used to determine the first configuration information.

In a possible design, in Implementation 1 to Implementation 3, the management operation includes one of the following: a setup operation, an update operation, a lock operation, an unlock operation, or a delete operation.

In a possible design, in Implementation 1 to Implementation 3, the first parameter includes at least one of the following: a type of the management operation performed on the communication apparatus; a first state, where the first state includes an expected state of the communication apparatus and/or an expected state of a security capability module that is in the communication apparatus and on which the management operation is to be performed; indication information of a security capability module that is in the communication apparatus and on which the management operation is to be performed; or indication information of an algorithm that is in a security capability module of the communication apparatus and on which the management operation is to be performed.

In a possible design, in Implementation 1 and Implementation 2, the first feedback information further includes the first configuration information.

In Implementation 4, the first information includes the first configuration information.

According to a seventh aspect, an embodiment of this application provides a communication apparatus. The communication apparatus may be configured to implement the communication method in the third aspect, that is, configured to perform an operation of the second entity in the method according to the third aspect. In a possible implementation, the communication apparatus may include one-to-one corresponding modules or units to perform the methods/operations/steps/actions described in the third aspect. The module or the unit may be a hardware circuit, may be software, or may be implemented by a hardware circuit in combination with software.

In a possible implementation, the apparatus includes a communication unit and a processing unit. The communication unit is configured to receive and/or send information. The processing unit is configured to: receive request information from a third entity through the communication unit, where the request information is used to request to set up a first entity, and the first entity is an entity that provides a security capability for the third entity; send second feedback information to the third entity through the communication unit, where the second feedback information indicates information for setting up the first entity; and receive sixth information from the first entity through the communication unit, where the sixth information includes first configuration information of the first entity, and the sixth information indicates whether the first entity is successfully configured with the first configuration information.

In a possible design, the second feedback information includes a download address of the first entity.

In a possible design, the request information includes indication information of a security capability module in the first entity.

In a possible design, the processing unit is further configured to send seventh information to the third entity through the communication unit, where the seventh information indicates a second security capability, and the second security capability is a security capability of the first entity.

In a possible design, the seventh information includes indication information of the second security capability and identification information of the first entity.

According to an eighth aspect, an embodiment of this application provides a communication apparatus. The communication apparatus may be configured to implement the communication method in the fourth aspect, that is, configured to perform an operation of the third entity in the method according to the fourth aspect. In a possible implementation, the communication apparatus may include one-to-one corresponding modules or units to perform the methods/operations/steps/actions described in the fourth aspect. The module or the unit may be a hardware circuit, may be software, or may be implemented by a hardware circuit in combination with software.

In a possible implementation, the apparatus includes a communication unit and a processing unit. The communication unit is configured to receive and/or send information. The processing unit is configured to: send request information to a second entity through the communication unit, where the request information is used to request to set up a first entity, and the first entity is an entity that provides a security capability for a third entity; receive second feedback information from the second entity through the communication unit, where the second feedback information indicates information for setting up the first entity; and set up the first entity based on the second feedback information.

In a possible design, the second feedback information includes a download address of the first entity.

In a possible design, the request information includes indication information of a security capability module in the first entity.

In a possible design, the processing unit is further configured to receive seventh information from the second entity through the communication unit, where the seventh information indicates a second security capability, and the second security capability is a security capability of the first entity.

In a possible design, the seventh information includes indication information of the second security capability and identification information of the first entity.

According to a ninth aspect, an embodiment of this application provides a communication apparatus, including a processor configured to cause, by executing a computer program (or computer-executable instructions) stored in a memory and/or by using a logic circuit, the apparatus to perform the method in any one of the foregoing aspects and the possible implementations of the aspects.

In a possible implementation, the apparatus further includes the memory.

In a possible implementation, the processor and the memory are integrated together.

In another possible implementation, the memory is located outside the communication apparatus.

The communication apparatus further includes a communication interface. The communication interface is for communication between the communication apparatus and another device, for example, for data and/or signal sending or receiving. For example, the communication interface may be a transceiver, a circuit, a bus, a module, or another type of communication interface.

According to a tenth aspect, an embodiment of this application provides a communication system, including a communication apparatus configured to perform an operation of the first entity in the method provided in the first aspect or the second aspect, and a communication apparatus configured to perform an operation of the second entity in the method provided in the first aspect or the second aspect. The communication apparatus configured to perform the operation of the first entity in the method provided in the first aspect or the second aspect is, for example, the communication apparatus in the fifth aspect, and the communication apparatus configured to perform the operation of the second entity in the method provided in the first aspect or the second aspect is, for example, the communication apparatus that may serve as the second entity in the sixth aspect.

In a possible design, the system further includes a communication apparatus configured to perform an operation of the third entity in the method provided in the first aspect or the second aspect. The communication apparatus configured to perform the operation of the third entity in the method provided in the first aspect or the second aspect is, for example, the communication apparatus that may serve as the third entity in the sixth aspect.

According to an eleventh aspect, an embodiment of this application provides a communication system, including a communication apparatus configured to perform an operation of the first entity in the method provided in the third aspect or the fourth aspect, and a communication apparatus configured to perform an operation of the second entity in the method provided in the third aspect or the fourth aspect. The communication apparatus configured to perform the operation of the second entity in the method provided in the third aspect or the fourth aspect is, for example, the communication apparatus in the seventh aspect.

In a possible design, the system further includes a communication apparatus configured to perform an operation of the third entity in the method provided in the third aspect or the fourth aspect. The communication apparatus configured to perform the operation of the third entity in the method provided in the third aspect or the fourth aspect is, for example, the communication apparatus in the eighth aspect.

According to a twelfth aspect, an embodiment of this application provides a communication system, including the communication apparatus in the seventh aspect and the communication apparatus in the eighth aspect.

According to a thirteenth aspect, an embodiment of this application further provides a computer program. When the computer program is run on a computer, the computer is caused to perform the method according to any one of the foregoing aspects.

According to a fourteenth aspect, an embodiment of this application further provides a computer-readable storage medium. The computer-readable storage medium stores a computer program. When the computer program is executed by a computer, the computer is caused to perform the method according to any one of the foregoing aspects.

According to a fifteenth aspect, an embodiment of this application further provides a chip. The chip is configured to read a computer program stored in a memory, to perform the method according to any one of the foregoing aspects.

According to a sixteenth aspect, an embodiment of this application further provides a chip system. The chip system includes a processor, configured to support a computer apparatus in implementing the method according to any one of the foregoing aspects. In a possible design, the chip system further includes a memory, and the memory is configured to store a program and data that are necessary for the computer apparatus. The chip system may include a chip, or may include a chip and another discrete component.

According to a seventeenth aspect, an embodiment of this application further provides a computer program product including computer-executable instructions. When the computer program product is run, some or all steps of the method according to any one of the foregoing aspects are performed.

For technical effects that can be achieved in any one of the third aspect to the seventeenth aspect, refer to the descriptions of the technical effects that can be achieved in any one of the possible designs in the first aspect or the second aspect. Details are not described herein again.

### BRIEF DESCRIPTION OF DRAWINGS

FIG. 1 is a diagram of an architecture of a communication system according to an embodiment of this application;

FIG. 2 is a diagram of a structure of a gear according to an embodiment of this application;

FIG. 3 is a diagram of state transition according to an embodiment of this application;

FIG. 4 is a diagram of configuration information of a gear according to an embodiment of this application;

FIG. 5 is a flowchart of a first communication method according to an embodiment of this application;

FIG. 6 is a flowchart of a second communication method according to an embodiment of this application;

FIG. 7 is a flowchart of a third communication method according to an embodiment of this application;

FIG. 8 is a flowchart of a fourth communication method according to an embodiment of this application;

FIG. 9 is a diagram of a gear update scenario according to an embodiment of this application;

FIG. 10 is a flowchart of a fifth communication method according to an embodiment of this application;

FIG. 11 is a flowchart of a sixth communication method according to an embodiment of this application;

FIG. 12 is a flowchart of a seventh communication method according to an embodiment of this application;

FIG. 13 is a flowchart of an eighth communication method according to an embodiment of this application;

FIG. 14 is a flowchart of a ninth communication method according to an embodiment of this application;

FIG. 15 is a flowchart of a tenth communication method according to an embodiment of this application;

FIG. 16 is a flowchart of an eleventh communication method according to an embodiment of this application;

FIG. 17 is a diagram of a structure of a communication apparatus according to an embodiment of this application; and

FIG. 18 is a diagram of a structure of another communication apparatus according to an embodiment of this application.

### DESCRIPTION OF EMBODIMENTS

This application provides a communication method and apparatus. The method and the apparatus are based on a same technical concept. Because problem-resolving principles of the method and the apparatus are similar, mutual reference may be made to implementations of the apparatus and the method. Details are not described again.

The following describes in detail embodiments of this application with reference to accompanying drawings.

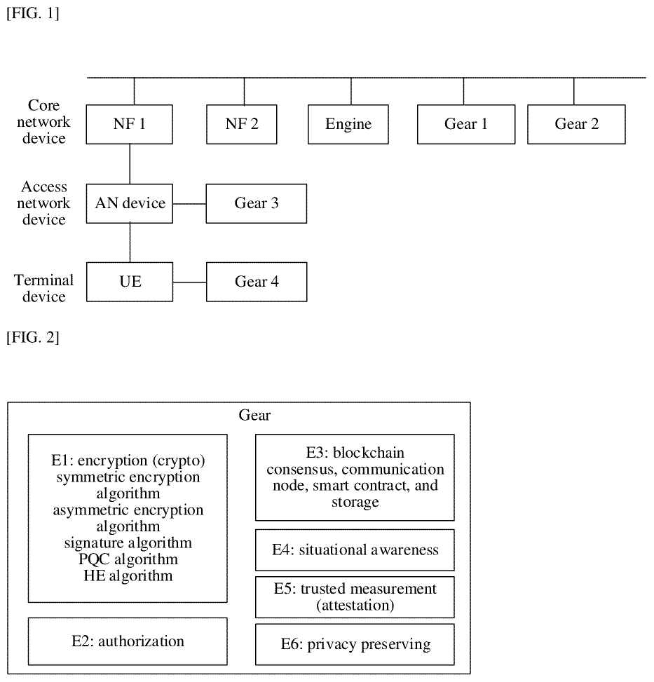

FIG. 1 is a diagram of an architecture of a communication system according to an embodiment of this application. As shown in FIG. 1, the communication system includes a terminal device, an access network (AN) device, and a core network (CN) device. The terminal device may access a data network through the AN device and the CN device.

In this application, the terminal device may also be referred to as user equipment (UE), a mobile station (MS), a mobile terminal (MT), or the like, is a device having a wireless transceiver function, and may be configured to provide voice or data connectivity for a user. The terminal device may alternatively be an internet of things device.

For example, the terminal device includes a handheld device, a vehicle-mounted device, or the like that has a wireless connection function. Currently, the terminal device may be: a mobile phone, a tablet computer, a notebook computer, a palmtop computer, a mobile internet device (MID), a wearable device (for example, a smartwatch, a smart band, or a pedometer), a vehicle-mounted device (for example, a vehicle, a bicycle, an electric vehicle, an airplane, a ship, a train, or a high-speed railway), a satellite terminal, a virtual reality (VR) device, an augmented reality (AR) device, a smart point of sale (POS) machine, customer-premises equipment (CPE), a wireless terminal in industrial control, a smart home device (for example, a refrigerator, a television, an air conditioner, or an electricity meter), a smart robot, a robot arm, a workshop device, a wireless terminal in self-driving, a wireless terminal in remote medical, a wireless terminal in a smart grid, a wireless terminal in transportation safety, a wireless terminal in a smart city, a wireless terminal in a smart home, a flight device (for example, a smart robot, a hot air balloon, an uncrewed aerial vehicle, or an airplane), or the like. The terminal device may alternatively be another device having a terminal function. For example, the terminal device may alternatively be a device that functions as a terminal in D2D communication.

A device form of the terminal is not limited in this embodiment of this application. An apparatus configured to implement a function of the terminal device may be a terminal device, or may be an apparatus that can support the terminal device in implementing the function, for example, a chip system. The apparatus may be mounted in the terminal device or used in cooperation with the terminal device. In embodiments of this application, the chip system may include a chip, or may include a chip and another discrete device.

The AN device in this application is a device that provides a wireless communication function for the terminal device. As a node in a radio access network, the AN device may also be referred to as a base station, a radio access network (RAN) node (or device), or an access point (AP). The AN device is configured to help the terminal device implement wireless access. The communication system may include a plurality of AN devices. The plurality of AN devices may be nodes of a same type, or may be nodes of different types. In some scenarios, roles of the AN device and the terminal device are relative. For example, a network element #A may be a helicopter or an uncrewed aerial vehicle, and may be configured as a mobile base station to access the RAN through a network element #B. For terminal devices that access the RAN through the network element #A, the network element #A is a base station. However, for the network element #B, the network element #A is a terminal device. The AN device and the terminal device are sometimes referred to as communication apparatuses.

In a possible scenario, the AN device may be a base station, an evolved NodeB (eNodeB), a transmission and reception point (TRP), a transmitting point (TP), a next generation NodeB (gNB), a next generation base station in a 6th generation (6G) mobile communication system, a base station in a future mobile communication system, a satellite, an access point (AP) in a wireless fidelity (Wi-Fi) system, an integrated access and backhaul (IAB) node, or an AN device that is in a non-terrestrial network (NTN) communication system of a mobile switching center and that may be deployed on a high-altitude platform or a satellite, or the like. The AN device may be a macro base station, a micro base station, or an indoor base station, a relay node or a donor node, or a radio controller in a cloud RAN (CRAN) scenario. The AN device may alternatively be a device that functions as a base station in device to device (D2D) communication, internet of vehicles communication, uncrewed aerial vehicle communication, or machine communication. Optionally, the AN device may alternatively be a server, a wearable device, a vehicle, a vehicle-mounted device, or the like. For example, an access network device in a vehicle to everything (V2X) technology may be a road side unit (RSU).

In another possible scenario, a plurality of AN devices collaborate to assist the terminal device in implementing radio access, and different AN devices separately implement some functions of a base station. For example, the AN device may be a central unit (CU), a distributed unit (DU), a CU-control plane (CP), a CU-user plane (UP), a radio unit (RU), or the like. The CU and the DU may be separately arranged, or may be included in a same network element, for example, a baseband unit (BBU). The RU may be included in a radio frequency device or a radio frequency unit, for example, included in a remote radio unit (RRU), an active antenna unit (AAU), or a remote radio head (RRH). It may be understood that the AN device may be a CU node, a DU node, or a device including a CU node and a DU node. In addition, the CU may be classified as an AN device in an access network RAN, or the CU may be classified as an AN device in a core network CN. This is not limited herein.

In different systems, the CU (or the CU-CP and the CU-UP), the DU, or the RU may alternatively have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

In embodiments of this application, a form of the AN device is not limited. An apparatus configured to implement a function of the AN device may be an AN device, or may be an apparatus that can support the AN device in implementing the function, for example, a chip system. The apparatus may be mounted in the AN device or used in cooperation with the AN device.

The AN device and the terminal device may be at fixed locations, or may be movable. The AN device and the terminal device may be deployed on land, including indoor devices, outdoor devices, handheld devices, or vehicle-mounted devices; may be deployed on water; or may be deployed on an airplane, a balloon, or an artificial satellite in the air. Application scenarios of the AN device and the terminal device are not limited in embodiments of this application.

In this application, the CN device is a network element included in a CN part in a mobile communication system. For example, the CN device is a network function (NF) network element included in the CN part. The CN device can connect the terminal device to different data networks, and perform services such as charging, mobility management, session management, and user plane forwarding. Currently, some examples of the NF network element are a unified data management (UDM) network element, a unified database (UDR) network element, a network exposure function (NEF) network element, an application function (AF) network element, a policy control function (PCF) network element, an access and mobility management function (AMF) network element, a session management function (SMF) network element, a user plane function (UPF) network element, a network repository function (NRF) network element, and the like.

It should be understood that, in mobile communication systems of different standards, NF network elements having a same function may have different names. A specific name of an NF network element having each function is not limited in embodiments of this application.

To manage a security function of each node in a communication system, the communication system further includes a trusted engine and a trusted enabler unit (which may also be referred to as a security capability node or a security function, and is referred to as a gear below).

In this application, the engine may be configured to manage a security function of each node in the communication system. For example, the engine may generate a network policy based on artificial intelligence or a preset rule, and initiate a management procedure to the gear based on the generated network policy. The gear then configures and stores configuration information of the gear (gear profile), so that the gear provides, based on the configuration information of the gear, a security capability for a node bound to the gear.

The engine may be an NF. Alternatively, when the AN device meets a condition required for managing a security function, the AN device may serve as an engine. For example, the condition includes at least one of the following: a computing power of the AN device meets a specified computing power requirement, a quantity of nodes connected to the AN device exceeds a specified quantity threshold, or the like.

The engine may further have other functions, for example, configure and/or schedule a security capability, and determine a trusted policy at a production network layer.

In this application, the gear may be bound (or correspond) to one or more nodes in the communication system, and serve as a security function to provide a security capability for the bound one or more nodes. For example, the security capability provided by the gear may include at least one of the following: authentication, encryption/decryption, authorization, and the like of a current 5G mobile communication system, and blockchain, trusted measurement, situational awareness, a privacy preserving function, and the like that may be supported by a system evolved from 5G, for example, a sixth generation (the 6th generation, 6G) mobile communication system.

The gear may be deployed on a terminal device side, an AN device side, or a CN device side. In this application, the gear may be an actual physical function, or may be a virtual logical function. The gear and the node bound to the gear may be located in different apparatuses. In other words, the gear may be independently deployed, or may be co-deployed as a logical function with the node bound to the gear.

For example, when the gear is bound to the terminal device, the gear may be deployed on an outer side of the bound terminal device, or may be deployed on the bound terminal device. For example, a gear 4 is bound to the UE. The gear 4 may be deployed on the UE as a logical function, or may be independently deployed on an outer side of the UE as a physical function (as shown in FIG. 1), or may be deployed on an apparatus outside the UE as a logical function.

When the gear is bound to the AN device, the gear may be deployed outside the bound AN device, or may be deployed on the bound AN device. For example, a gear 3 is bound to the AN device. The gear 3 may be deployed, as a logical function, on the AN device; or may be independently deployed, as a physical function, on an outside side of the AN device (as shown in FIG. 1); or may be deployed, as a logical function, on an apparatus outside the AN device. Optionally, when the AN device includes the CU and the DU, the gear may be deployed only on the CU, or may be deployed on both the CU and the DU.

When the gear is bound to the CN device, the gear may be deployed on the bound CN device, or may be deployed outside the bound CN device. For example, a gear 1 is bound to an NF 1. The gear 1 may be deployed on the NF 1 as a logical function, or may be independently deployed on a bus as an NF of a core network (as shown in FIG. 1).

It should be understood that the foregoing deployment form is merely an example for description. Regardless of whether the gear is deployed on the terminal device side, the AN device side, or the CN device side, a basis of multi-party negotiation and trusted communication may be formed by using a unified external interface.

FIG. 2 shows a possible structure of a gear. As shown in FIG. 2, the gear may include at least one security capability module (referred to as an enabler module below, for example, E1 to E6 in FIG. 2). Each enabler module may include an algorithm (which may also be referred to as a security algorithm) used to provide a security capability, and different enabler modules may include different algorithms.

The gear may provide a security capability for a node bound to the gear. When the node needs security protection, the node may invoke the gear, and the gear executes an algorithm that is in an enabler module and that is requested by the node, to provide a corresponding security capability for the node. For example, when the node needs to perform encryption, the node may invoke the gear to execute an encryption algorithm in an enabler module whose name is encryption.

To enable the gear to better provide a security capability for the node bound to the gear, the gear needs to meet a security requirement of the node bound to the gear. The node may learn of the security capability provided by the gear, that is, learn of an enabler module in the gear and an algorithm supported by the enabler module.

The communication system includes the engine and the gear, and the engine may configure the gear serving as a security function, so that the security function can be flexibly configured. In addition, in the system, the gear serving as a security function and a node serving as a communication function may be separated, to facilitate independent evolution, update, and upgrade of the security function.

It may be understood that the foregoing network elements or functions may be network elements in a hardware device, or may be logical functions. In a possible implementation, the foregoing network elements or functions may be implemented by one device, or may be jointly implemented by a plurality of devices, or may be implemented by one functional module in one device. This is not specifically limited in embodiments of this application.

It should be noted that the communication system shown in FIG. 1 does not constitute a limitation on a communication system to which embodiments of this application are applicable. Therefore, the communication method provided in embodiments of this application may be further applicable to communication systems of various standards, for example, a long term evolution (LTE) communication system, a 5G communication system, a 6G communication system, a future communication system, V2X, long term evolution-internet of vehicles (LTE-V), vehicle to vehicle (V2V), internet of vehicles, machine type communication (MTC), internet of things (IoT), long term evolution-machine to machine (LTE-M), machine to machine (M2M), internet of things, and a non-terrestrial network (NTN) system. In addition, it should be further noted that names of network elements/functions in the communication system are not limited in embodiments of this application. Network elements/network functions that implement a same function may have names in communication systems of different standards or in different scenarios. For another example, when a plurality of network elements are integrated into a same physical device, the physical device may also have another name.

For ease of understanding this application, the following explains some terms in this application.

1. States of a gear and states of an enabler module in the gear.

The states of the gear may include a configured state and a terminated state. Optionally, the states of the gear may further include: a ready state, a locked state, and a disabled state.

The ready state is a state after the gear is normally started. When the gear is in the ready state, the gear is available and waits to be configured (or managed). The configured state is an active state after the gear is configured. When the gear is in the configured state, the gear can be invoked or updated. When the gear is in the locked state, the gear can be invoked but cannot be updated. When the gear is in the disabled state, the gear cannot be invoked but can be updated. The gear can be restored from the disabled state to the configured state. The terminated state may also be referred to as a network exit state, and is an end state of a lifetime of the gear. When the gear is configured to the terminated state, the gear can delete all usage data. Because the gear that enters the terminated state is deleted after a current operation ends, the terminated state is not written into a gear profile for a long time.

The states of the enabler module in the gear may include a configured state and a terminated state. Optionally, the states of the enabler module may further include a locked state and a disabled state.

The configured state is an active state after the enabler module is configured. When the enabler module is in the configured state, the enabler module can be invoked or updated. When the enabler module is in the locked state, the enabler module can be invoked but cannot be updated. When the enabler module is in the disabled state, the enabler module cannot be invoked but can be updated. The enabler module can be restored from the disabled state to the configured state. The terminated state may also be referred to as a network exit state, and is an end state of a lifetime of the enabler module. When the enabler module is configured to the terminated state, the enabler module can delete all usage data. Because the enabler module that enters the terminated state is deleted after a current operation ends, the terminated state is not written into the gear profile for a long time.

In some examples, the state of the enabler module in the gear may be determined based on the state of the gear. For example, after the gear transitions from the ready state to the configured state, some enabler modules in the gear are also activated and enter the configured state, and other enabler modules in the gear enter the disabled state. In some other examples, the state of the enabler module in the gear may be separately configured. For example, an engine configures some enabler modules in the gear to enter the disabled state.

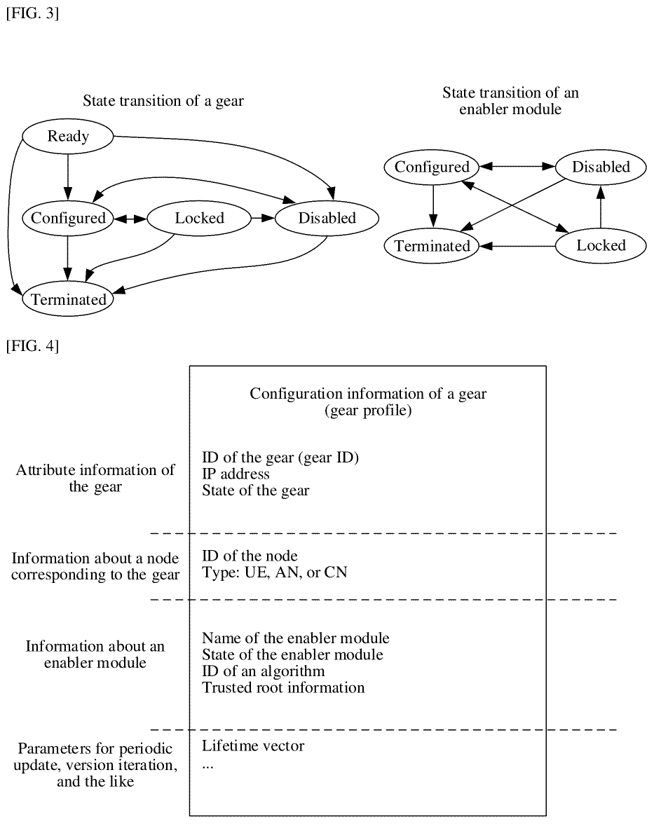

The state of the gear and the state of the enabler module are not immutable. Both the gear and the enabler module can perform state transition. In this application, management of the gear may include state transition of the gear and/or state transition of the enabler module in the gear. FIG. 3 shows a possible state transition manner. Refer to FIG. 3. The following describes state transition of the gear and state transition of the enabler module in the gear.

State transition of the gear: The gear may transition from the ready state to the configured state, the disabled state, or the terminated state. The gear may transition from the configured state to the locked state, the disabled state, or the terminated state. The gear may transition from the locked state to the configured state, the disabled state, or the terminated state. The gear may transition from the disabled state to the configured state or the terminated state.

State transition of the enabler module in the gear: The enabler module may transition from the configured state to the locked state, the disabled state, or the terminated state. The enabler module may transition from the locked state to the configured state, the disabled state, or the terminated state. The enabler module may transition from the disabled state to the configured state or the terminated state.

Optionally, an algorithm in the enabler module may also have a corresponding state, and the algorithm in the enabler module may also perform state transition. For specific content of the state of the algorithm, refer to the state of the enabler module. For specific content of state transition of the algorithm, refer to the state transition of the enabler module. Details are not described herein again.

In some possible implementations, the state of the gear and the state of the enabler module may not be set, and two flag bits are set. One flag bit indicates whether the gear or the enabler module can be invoked, and the other flag bit indicates whether the gear or the enabler module can be updated. In this way, the state of the gear and the state of the enabler module can be covered by using the two flag bits.

2. Gear profile:

In this application, the gear profile may be used to manage the gear. For example, as shown in FIG. 4, the gear profile may include one or more of the following:
(1) Attribute information of the gear: may include one or more of an identity (ID) of the gear (namely, a gear ID), an internet protocol (IP) address of the gear, a state of the gear (namely, a gear state), or the like.
(2) Information about a node bound to the gear: may include an ID (namely, a node ID), a type, and/or the like of the node bound to the gear, where the type is, for example, a terminal device, an AN device, or a CN device.
(3) Information about the enabler module in the gear: may include one or more of a name (namely, enabler names) and/or an ID of the enabler module, a state (namely, enabler state) of the enabler module, a name and/or an ID (namely, enabler algorithms ID) of the algorithm in the enabler module, trusted root information (TRoot information), or the like.
(4) Parameter used for periodic update, version iteration, or the like of the gear, for example, a lifetime vector.

3. Configuration manner of the gear:

In this application, the configuration manner of the gear may include one of the following:

Manner 1: Remote download: The gear, an apparatus in which the gear is located, or the node bound to the gear downloads, from a first server, at least one of the following: a code image of the gear, a code image of the enabler module in the gear, or a code image of the algorithm in the enabler. The first server may be a server provided by an operator, or may be a server including all gears supported by a network or system in which the gear is located (where the server may be referred to as a full transmission device (full gear)), or may be a cloud server or the like. Optionally, before the remote download is performed, the gear, the apparatus in which the gear is located, or the node bound to the gear may first obtain a download address, namely, an address of the first server, and obtain a download permission.

Manner 2: Local configuration: A node may be bound to one or more gears. The gear includes all enabler modules supported by a network or system in which the gear is located; or the gear is a gear of a default template, for example, the gear includes a default enabler module. In some examples, in the gear, a state of an enabler module corresponding to a security capability that is not needed by the node is the disabled state, so that such enabler modules cannot be invoked. In some other examples, some enabler modules and algorithms run in the gear, that is, the enabler modules and algorithms are activated, and another enabler module may be activated when required. In this way, the node may invoke the activated enabler modules and algorithms.

In this application, an entity may be a terminal device, an AN device, a CN device, an engine, or a gear. The entity may be a network element in a hardware device, or may be a logical function. The logical function is, for example, a software function running on dedicated hardware, or a virtualized function instantiated on a platform (for example, a cloud platform).

In this application, information may alternatively be replaced with a message, signaling, or the like.

In this application, having in having a security capability by an entity may be replaced with verbs having a same or similar meaning, for example, possessing or supporting.

In this application, homomorphic encryption is an encryption algorithm that meets a ciphertext homomorphic operation property. Output data may be obtained by processing data that has undergone homomorphic encryption, and a result of decrypting the output data is the same as a result of processing the unencrypted raw data by using the same processing method.

In this application, non-homomorphic encryption means that no homomorphic encryption is set.

In this application, trusted measurement may also be referred to as remote attestation, and may transfer trusted information of a terminal platform to a network environment, to implement trusted communication of a user in the network.

In this application, unless otherwise specified, a quantity of nouns represents “a singular noun or plural nouns”, that is, “one or more”. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists. “At least one of the following items (pieces)” or a similar expression thereof refers to any combination of these items (pieces), including a single item (piece) or any combination of a plurality of items (pieces).

In addition, it should be understood that in the descriptions of this application, words such as “first” and “second” are merely used for distinguishing, and should not be understood as an indication or implication of relative importance or an indication or implication of a sequence.

Currently, in a mobile communication network, an operator manages a communication apparatus by using a management system. A security function of the communication apparatus is fixed. A security function corresponding to the communication apparatus changes only when the communication apparatus is updated and the network is upgraded, for example, a security function is added, updated, or deleted. In this way, when an application scenario changes, the security function cannot be flexibly updated in time, so that configuration of the security function is delayed. Furthermore, the communication apparatus cannot actively trigger a management procedure of the security function, so that the security function cannot be configured based on a requirement of the communication apparatus.

In addition, currently, the security function is tightly coupled to a communication function of the communication apparatus. Management of the communication function of the communication apparatus is delivered by a management plane. For example, the operator sets up, updates, or deletes the communication function of the communication apparatus by using an OAM device. Therefore, the communication function of the communication apparatus cannot be flexibly configured. Consequently, it is difficult to upgrade the security function of the communication apparatus, and the security function cannot be flexibly configured.

The following describes a method for resolving the foregoing technical problems with reference to the accompanying drawings. In the following method, a first entity is bound to or corresponds to a third entity, and may provide a security capability for the third entity. Because the third entity needs a security capability, the third entity may also be referred to as a demander. A second entity may be configured to manage the first entity. A fourth entity may be the second entity or the third entity. For example, the first entity is a gear, the second entity is an engine, the third entity is a node bound to the gear, and the fourth entity is the engine or the node bound to the gear.

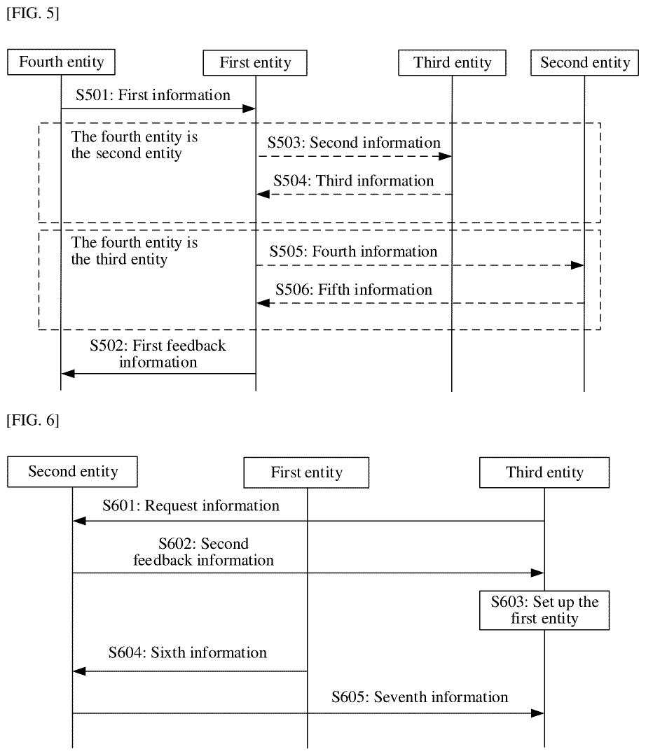

To resolve the foregoing problems, an embodiment of this application provides a communication method. The method may be applied to the communication system shown in FIG. 1. The following describes a procedure of the method in detail with reference to a flowchart shown in FIG. 5.

S501: A fourth entity sends first information, and correspondingly, a first entity receives the first information. The first information may be used to determine first configuration information of the first entity. The first configuration information is configuration information used by the first entity to provide a security capability for a third entity. For example, the first entity is a gear, and the first configuration information is a gear profile.

Optionally, the fourth entity sends the first information in one of the following scenarios.

Scenario 1: The fourth entity is a second entity (for example, an engine), and the second entity generates a security policy. The security policy may be a security policy of a network in which the second entity is located. For example, the security policy may include a security capability that at least one entity needs to have and/or a security capability that at least one entity does not need to have. The at least one entity includes the third entity. For example, the security policy is shown in Table 1. It can be learned from the second row and the third row in Table 1 that if the third entity is an NF, a security capability that the third entity needs to have includes blockchain, and a security capability that the third entity does not need to have includes homomorphic encryption. It can be learned from the second row and the fourth row in Table 1 that, if the third entity is a terminal device, a security capability that the third entity needs to have may include trusted measurement, and the security capability that the third entity does not need to have includes homomorphic encryption. It can be learned from the second row in Table 1 that if the third entity is an AN device, a security capability that the third entity does not need to have includes homomorphic encryption.

TABLE 1

| Node | Security capability |
|---|---|
| All nodes | Non-homomorphic encryption |
| All NFs | Blockchain |
| Some terminal devices | Trusted measurement |

The following describes a manner in which the second entity obtains the security policy.

In some possible implementations, when an application scenario of the network changes, for example, when the second entity determines, through situational awareness, that the application scenario of the network changes, the second entity may generate the security policy based on an artificial intelligence (AI) technology. For example, the second entity may use the current application scenario as input data of a first AI model, to obtain the security policy corresponding to the current application scenario. The first AI model may be trained in advance, or may be trained online in real time.

In some other possible implementations, the second entity may generate the security policy based on a first expert library and/or a first preset rule. The first expert library may include a correspondence between at least one group of application scenarios and a security policy. The first preset rule may include a correspondence between at least one condition and a security policy. In this way, when determining that the at least one condition is met, the second entity may generate the corresponding security policy. The following uses an example to describe the correspondence between at least one condition and a security policy in the first preset rule.

For example, the at least one condition includes at least one of the following: the network evolves from 5G to 6G and/or is compatible with 6G; or the network is upgraded to 6G online. The security policy corresponding to the at least one condition includes that all nodes in the network need to have a 6G security capability (for example, blockchain).

For another example, the at least one condition includes at least one of the following: the operator has configured the first entity, but does not bind the third entity to the first entity; or the operator has bound the first entity to the third entity, but does not activate the first entity. The security policy corresponding to the at least one condition includes that the third entity needs to have at least one security capability that can be provided by the first entity.

In still some possible implementations, the operator may set the security policy, and input the security policy into the second entity. For example, when the operator needs to upgrade the network to 6G, the operator may determine that all nodes in the network need to have a 6G security capability (for example, blockchain), to input the corresponding security policy into the second entity.

Scenario 2: The fourth entity is the third entity (namely, a demander), and the third entity generates a security requirement of the third entity. The security requirement may include a security capability that the third entity needs to have and/or a security capability that the third entity does not need to have. For example, the security requirement may be shown in Table 2. The third entity does not need to have a security capability corresponding to a requirement 0, but needs to have a security capability corresponding to a requirement 1. It should be understood that the numbers corresponding to the requirements in Table 2 are merely examples. In actual application, the requirements may alternatively correspond to other information, for example, correspond to other numbers.

TABLE 2

| Security capability | Requirement |
|---|---|
| Homomorphic encryption | 0 |
| Blockchain | 1 |
| Trusted measurement | 1 |

The following describes a manner in which the third entity obtains the security requirement.

In some possible implementations, when an application scenario of the third entity changes, the third entity may generate the security requirement based on an artificial intelligence technology. For example, the third entity may use the current application scenario as input data of a second AI model, to obtain the security requirement corresponding to the current application scenario. The second AI model may be trained in advance, or may be trained online in real time.

In some other possible implementations, the third entity may generate the security requirement based on a second expert library and a second preset rule. The second expert library may include a correspondence between at least one group of application scenarios and a security requirement. The second preset rule may include a correspondence between one or more conditions and a security requirement. In this way, when determining that the one or more conditions are met, the third entity may generate the corresponding security requirement. The following uses an example to describe the correspondence between one or more conditions and a security requirement in the second preset rule.

For example, the one or more conditions include that: the third entity changes from needing to have a 5G security capability to needing to have a 5G security capability and a 6G security capability. The security requirement corresponding to the one or more conditions includes that the third entity needs to have a 6G security capability (for example, blockchain).

For another example, the one or more conditions include at least one of the following: the operator binds the first entity to the third entity, but has not activated the first entity. The security requirement corresponding to the one or more conditions includes that the third entity needs to have at least one security capability that can be provided by the first entity.

In still some possible implementations, the operator may set the security requirement, and input the security requirement into the third entity. For example, when the operator needs to upgrade the third entity to 6G, the operator may determine that the third entity needs to have a 6G security capability (for example, blockchain), to input the corresponding security requirement into the third entity.

In yet another possible implementation, the third entity may receive the security requirement input by a user through a user interface (UI). For example, the third entity is a terminal device. After inserting a 6G subscriber identity module (subscriber identity module, SIM) card into the third entity, the user may determine that the third entity needs to have a 6G security capability (for example, blockchain), and input the corresponding security requirement into the third entity through the UI (for example, a screen).

With reference to Implementation 1 to Implementation 4, the following describes a manner in which the first information is used to determine the first configuration information of the first entity.

Implementation 1: The first information indicates a first parameter used to perform a management operation on the first entity, and the first parameter is used to determine the first configuration information.

The management operation may include but is not limited to one of the following: a set up operation, an update operation, a lock operation, an unlock operation, or a delete operation. Correspondingly, a type of the management operation may include but is not limited to one of the following: setup, update, lock, unlock, and delete. Optionally, each type of management operation may correspond to at least one gear state transition. For example, Table 3 shows a possible correspondence between a type of management operation and gear state transition.

TABLE 3

| Type of management | | |
|---|---|---|
| operation | Start state | End state |
| Setup | Ready | Configured |
| Update | Configured | Disabled |
| | Disabled | Configured |
| Lock | Configured | Locked |
| Unlock | Locked | Configured |
| Delete | State other than | Terminated |
| | terminated | |

For example, the first parameter may include but is not limited to at least one of the following:

1. Type (which may be referred to as a management type (management type) below) of the management operation performed on the first entity, for example, setup, update, lock, unlock, or delete.

2. First state: may include an expected state of the first entity (which may be referred to as an expected state below), and/or an expected state (which may be referred to as an expected enabler state below) of a security capability module that is in the first entity and on which the management operation is to be performed.

The expected state of the first entity may be a state of the first entity after the management operation is performed on the first entity. For example, if the type of the management operation is setup, the expected state of the first entity may be a configured state. For another example, if the type of the management operation is lock, the expected state of the first entity may be a locked state.

The expected state of the security capability module that is in the first entity and on which the management operation is to be performed may be a state of the security capability module after the management operation is performed on the security capability module in the first entity. For example, if the unlock operation is performed on a security capability module #1, an expected state of the security capability module #1 is the configured state. For another example, if the lock operation is performed on the security capability module #1, the expected state of the security capability module #1 may be the locked state.

3. Indication information of a security capability module that is in the first entity and on which the management operation is to be performed, for example, a name (which may be referred to as an enabler name below) or an index of the security capability module that is in the first entity and on which the management operation is to be performed.

4. Indication information of an algorithm that is in a security capability module of the first entity and on which the management operation is to be performed, for example, a name or an ID (which may be referred to as an algorithm ID below) of the algorithm that is in the security capability module of the first entity and on which the management operation is to be performed.

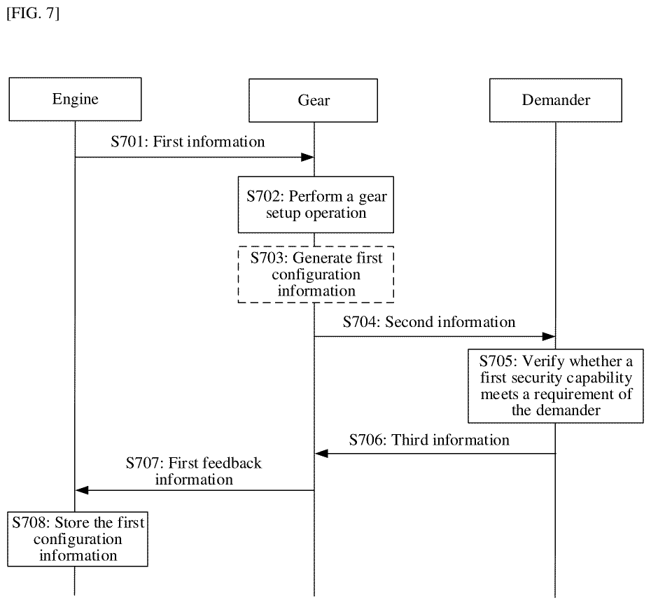

Optionally, when the management operation is different, the first parameter may also be different. For a correspondence between the management operation and the first parameter, refer to the following descriptions of methods shown in FIG. 7 to FIG. 15. Details are not described herein.

Before sending the first information indicating the first parameter, the fourth entity may obtain the first parameter. The following describes a manner in which the fourth entity obtains the first parameter.

In some possible implementations, the fourth entity is a second entity (for example, an engine). Before sending the first information, the second entity may map a security policy to the first parameter. For specific content of the security policy, refer to Scenario 1. Details are not described herein again.

Optionally, the second entity may map the security policy to the first parameter based on the security policy and current configuration information of the first entity. For example, the security policy is that security capabilities that all nodes need to have include blockchain. Before sending the first information, the second entity stores the configuration information of the first entity. If the configuration information of the first entity indicates that the security capability provided by the first entity does not include blockchain, the second entity may determine that in the first parameter, the type of the management operation performed by the first entity is update, the expected state of the security capability module that is in the first entity and on which the management operation is to be performed is the configured state, the name of the security capability module that is in the first entity and on which the management operation is to be performed is blockchain, and the indication information of the algorithm that is in the security capability module of the first entity and on which the management operation is to be performed is an ID of an algorithm related to blockchain.

In some other possible implementations, the fourth entity is the third entity (namely, a demander). Before sending the first information, the fourth entity may map a security requirement of the third entity to the first parameter.

Optionally, the third entity may map the security requirement to the first parameter based on the security requirement and a security capability that can be currently provided by the first entity. For specific content of the security requirement, refer to Scenario 2. Details are not described herein again. For example, the security requirement is that a security capability that the third entity needs to have includes blockchain. Before sending the first information, the third entity stores the security capability currently provided by the first entity. If the security capability currently provided by the first entity does not include blockchain, the third entity may determine that in the first parameter, the type of the management operation performed by the first entity is update, the expected state of the security capability module that is in the first entity and on which the management operation is to be performed is the configured state, the name of the security capability module that is in the first entity and on which the management operation is to be performed is blockchain, and the indication information of the algorithm that is in the security capability module of the first entity and on which the management operation is to be performed is an ID of an algorithm related to blockchain.

In some possible implementations, after receiving the first information, the first entity may perform configuration based on the first parameter, and generate the first configuration information corresponding to a current configuration. This is described below by using examples.

In some examples, the first entity may configure the first entity based on the first parameter. For example, in the first parameter, if the type of the management operation performed on the first entity is setup, the expected state of the first entity is the configured state, the expected state of the security capability module that is in the first entity and on which the management operation is to be performed is the configured state, and the name of the security capability module that is in the first entity and on which the management operation is to be performed is blockchain, the first entity may change the state of the first entity from a ready state to the configured state, and change the state of the security capability module whose name is blockchain to the configured state. In this case, the first configuration information may include that: the state of the first entity is the configured state, the name of the security capability module includes blockchain, and the state of the security capability module whose name is blockchain is the configured state.

In some other examples, the first entity may configure the security capability module in the first entity based on the first parameter. For example, in the first parameter, if the type of the management operation performed on the first entity is update, the expected state of the security capability module that is in the first entity and on which the management operation is to be performed is the configured state, the name of the security capability module that is in the first entity and on which the management operation is to be performed is encryption, and the ID of the algorithm that is in the security capability module of the first entity and on which the management operation is to be performed is an ID of a symmetric encryption algorithm, the first entity may change the state of the security capability module whose name is encryption in the first entity to the configured state, and configure the symmetric encryption algorithm in the security capability module whose name is encryption. In this case, in the first configuration information, the name of the security capability module includes encryption, the state of the security capability module whose name is encryption is the configured state, and indication information of the algorithm in the security capability module whose name is encryption includes the ID of the symmetric encryption algorithm.

It should be understood that the foregoing two examples may alternatively be combined, that is, the first entity may configure the first entity and the security capability module in the first entity based on the first parameter.

Through Implementation 1, the first entity may obtain the first parameter from the fourth entity, and the first entity does not need to obtain the first parameter by analyzing a security policy or a security requirement, so that a calculation loss of the first entity can be reduced, and computing resources and power of the first entity can be saved.

Implementation 2: The first information indicates a security policy of at least one entity, the at least one entity includes the third entity, and the security policy is used to determine the first configuration information.

In Implementation 2, the fourth entity may be the second entity. For specific content of the security policy, refer to Scenario 1. Details are not described herein again.

Optionally, the security policy is used to determine a first parameter used to perform a management operation on the first entity, and the first parameter is used to determine the first configuration information. For specific content of the first parameter and a specific process in which the first entity determines the first configuration information based on the first parameter, refer to Implementation 1. For a specific process in which the first entity determines the first parameter based on the security policy, refer to the manner in which the second entity maps the security policy to the first parameter in Implementation 1. Details are not described herein again.

Through Implementation 2, the second entity may send the security policy to the first entity serving as a security function, and the first entity determines the first configuration information of the first entity based on the security policy. In this way, the second entity does not need to determine, for each security function, a parameter used to perform the management operation, so that efficiency of configuring the security function by the second entity can be improved, a calculation loss of the second entity can be reduced, and computing resources and power of the second entity can be saved.

Implementation 3: The first information indicates a security requirement of the third entity, and the security requirement is used to determine the first configuration information.

In Implementation 3, the fourth entity may be the third entity. For specific content of the security requirement, refer to Scenario 2. Details are not described herein again.

Optionally, the security requirement is used to determine a first parameter used to perform a management operation on the first entity, and the first parameter is used to determine the first configuration information. For specific content of the first parameter and a specific process in which the first entity determines the first configuration information based on the first parameter, refer to Implementation 1. For a specific process in which the first entity determines the first parameter based on the security requirement, refer to the manner in which the third entity maps the security requirement to the first parameter in Implementation 1. Details are not described herein again.

In some implementations, a security capability in the first configuration information determined by the first entity completely matches the security requirement. For example, the security requirement is that security capabilities that the third entity needs to have include blockchain and encryption. In the first configuration information, states of a security capability module whose name is blockchain and a security capability module whose name is encryption are both the configured state. In other words, security capabilities in the first configuration information include blockchain and encryption.

In some other implementations, a security capability in the first configuration information determined by the first entity does not completely match the security requirement, and the first entity determines the first configuration information based on the first information and configuration information that is of the first entity before receiving the first information. For example, in the configuration information of the first entity before receiving the first information, states of a security capability module whose name is encryption and a security capability module whose name is authentication are both the configured state. The security requirement is that a security capability that the third entity needs to have includes blockchain. In this case, the security capabilities in the first configuration information determined by the first entity include blockchain, encryption, and authentication. For another example, in the configuration information of the first entity before receiving the first information, a state of a security capability module whose name is encryption is the configured state. The security requirement is that a security capability that the third entity needs to have includes blockchain. If the first entity cannot obtain blockchain, the security capability in the first configuration information determined by the first entity includes encryption.

Through Implementation 3, the third entity may send the security requirement to the first entity serving as a security function, and the first entity determines the first configuration information of the first entity based on the security requirement. In this way, the third entity does not need to analyze the security requirement, so that a calculation loss of the third entity can be reduced, and computing resources and power of the third entity can be saved.

Implementation 4: The first information includes the first configuration information.

In Implementation 4, the fourth entity may be the second entity. Before sending the first information, the second entity may determine, based on a security policy, a first parameter used to perform a management operation on the first entity, and generate the first configuration information based on the first parameter. For specific content of the first parameter, refer to Implementation 1. For a specific process in which the second entity may determine the first parameter based on the security policy, refer to the manner in which the second entity maps the security policy to the first parameter in Implementation 1. For a manner in which the second entity generates the first configuration information, refer to the manner in which the first entity generates the first configuration information in Implementation 1. Details are not described herein again.

Through Implementation 4, the first entity may obtain the first configuration information from the second entity, and the first entity does not need to obtain the first configuration information by analyzing a security policy or a security requirement, so that a calculation loss of the first entity can be reduced, and computing resources and power of the first entity can be saved.

S502: The first entity sends first feedback information, and correspondingly, the fourth entity receives the first feedback information. The first feedback information indicates whether the first entity is successfully configured with the first configuration information.

In some implementations, the first information in S501 is the first information in Implementation 1 or Implementation 2, and the fourth entity is the second entity. In this case, the first feedback information may further include the first configuration information. In this way, the second entity can obtain and store the first configuration information, to effectively manage the first entity.

In some other implementations, the first information in S501 is the first information in Implementation 1 or Implementation 3, and the fourth entity is the third entity. In this case, the first feedback information may further include indication information of a first security capability and an ID of the first entity. The first security capability is determined based on the first information, and is a security capability provided by the first entity for the third entity.

In some examples, the first security capability may be a security capability adjusted based on the first information. For example, before the first information is received, security capabilities provided by the first entity for the third entity include encryption and authentication. After the first information is received, security capabilities provided by the first entity for the third entity include encryption, authentication, and blockchain. The first security capability includes blockchain.

In some other examples, the first security capability may be all security capabilities provided by the first entity for the third entity after the security capability is adjusted based on the first information. For example, before the first information is received, security capabilities provided by the first entity for the third entity include encryption and authentication. After the first information is received, security capabilities provided by the first entity for the third entity include encryption, authentication, and blockchain. The first security capability includes encryption, authentication, and blockchain.

For example, the indication information of the first security capability may include at least one of the following: a state of the first entity, indication information of a security capability module corresponding to the first security capability in the first entity, indication information of an algorithm in the security capability module corresponding to the first security capability in the first entity, a state of the security capability module corresponding to the first security capability in the first entity, or a state of the algorithm in the security capability module corresponding to the first security capability in the first entity. For example, when the first security capability is blockchain, in the indication information of the first security capability, the state of the first entity may be the configured state, a name of the security capability module corresponding to the first security capability in the first entity is blockchain, the indication information of the algorithm in the security capability module corresponding to the first security capability in the first entity is an ID of an algorithm #1 in blockchain, and the state of the security capability module corresponding to the first security capability in the first entity is the configured state.

In this way, the third entity can obtain and store the first security capability, so that the first entity can be invoked to support the first security capability.

It should be understood that the first feedback information may be response information of the first information, or may be a notification message indicating whether the first entity is successfully configured with the first configuration information.

According to the method shown in FIG. 5, the fourth entity can configure the first entity based on the first information, so that the first entity can be configured quickly and flexibly. In addition, the fourth entity may configure the first entity by using signaling. Therefore, when the fourth entity perceives a change in an application scenario, the fourth entity may configure the first entity in time, so that the configuration of the first entity can meet a current requirement, and reliable security support is provided for the third entity. In addition, in the method, the first entity may be an entity independent of the third entity, the first entity may serve as a security function, and the third entity may serve as a communication function, so that the security function independent of the communication function can be flexibly configured, thereby facilitating independent evolution, update, and upgrade of the security function.

In addition, in the method, the third entity, as a security capability demander, may trigger the configuration of the first entity. This improves a capability of the third entity to control the first entity serving as a security function, so that the first entity can provide a security service for the third entity as required.

In some implementations, the fourth entity is the second entity. In other words, S501 includes: The first entity receives the first information from the second entity. In this case, the method shown in FIG. 5 may further include:

S503: The first entity sends second information to the third entity, and correspondingly, the third entity receives the second information from the first entity.

The second information indicates a first security capability provided by the first entity for the third entity, and the first security capability is determined based on the first information. For specific content of the first security capability, refer to S502. Details are not described herein again. In this way, the first entity can notify the third entity in time of the first security capability that can be provided by the first entity, so that the third entity invokes the first entity to support the first security capability.

For example, the second information includes indication information of the first security capability and identification information of the first entity. For specific content of the indication information of the first security capability, refer to S502. Details are not described herein again.

Optionally, after receiving the second information, the third entity may determine the first security capability provided by the first entity for the third entity, and verify whether the first security capability meets a requirement of the third entity. For example, the first security capability includes blockchain. In a security requirement of the third entity, a security capability that the third entity needs to have includes blockchain. In this case, the third entity may determine that the first security capability meets the requirement of the third entity. For another example, the first security capability includes encryption, authentication, and blockchain. In a security requirement of the third entity, a security capability that the third entity needs to have includes situational awareness. In this case, the third entity may determine that the first security capability does not meet the requirement of the third entity.

In some possible implementations, after S503, the method shown in FIG. 5 further includes:

S504: The third entity sends third information to the first entity, and correspondingly, the first entity receives the third information from the third entity. The third information indicates whether the first security capability meets a requirement of the third entity.

Case 1: The third information indicates that the first security capability meets the requirement of the third entity. In this case, in S502, the first feedback information may indicate that the first entity is successfully configured with the first configuration information. In this way, the second entity can learn that the first entity is successfully configured.

Case 2: The third information indicates that the first security capability does not meet the requirement of the third entity. The following describes operations of each entity in Case 2.

In an example, in S502, the first feedback information may indicate that the first entity fails to configure the first configuration information. In this way, the second entity can learn that the first entity is not successfully configured, and may further manage the first entity. For example, the third information and the first feedback information include indication information of a security capability #A, the security capability #A is a security capability that the third entity needs to have, and the first security capability does not include the security capability #A. The second entity may reconfigure the first entity based on the security capability #A. For a configuration manner, refer to S501. Details are not described herein again.

In another example, the third information may include indication information of a security capability #A, the security capability #A is a security capability that the third entity needs to have, and the first security capability does not include the security capability #A. The first entity may reconfigure the first entity based on the security capability #A. For a configuration manner, refer to S501. Details are not described herein again. The first entity may then perform the operations in S503 and S504 again until the security capability provided by the first entity meets the requirement of the third entity.

It should be understood that the third information may be response information of the second information, or may be a notification message indicating whether the first security capability meets the requirement of the third entity.

According to the method, the first entity can learn whether the first security capability meets the requirement of the third entity, so that the configuration of the first entity can be further adjusted based on the requirement of the third entity.

In some other implementations, the fourth entity is the third entity. In other words, S501 includes: The first entity receives the first information from the third entity. In this case, the method shown in FIG. 5 may further include:

S505: The first entity sends fourth information to the second entity, and correspondingly, the second entity receives the fourth information from the first entity. The fourth information includes the first configuration information, and the fourth information is used to register the first configuration information of the first entity.

Optionally, after receiving the fourth information, the second entity may determine the first configuration information, and verify whether the first configuration information meets a security policy. When the first configuration information meets the security policy, the first configuration information is successfully registered; or when the first configuration information does not meet the security policy, the first configuration information fails to be registered. For specific content of the security policy, refer to Scenario 1. Details are not described herein again.

For example, in the first configuration information, a security capability module in the configured state includes blockchain. In the security policy, a security capability that the third entity needs to have includes blockchain. In this case, the second entity may determine that the first configuration information meets the security policy, and the first configuration information can be successfully registered.

For another example, in the first configuration information, a security capability module in the configured state includes encryption, authentication, and blockchain. In the security policy, a security capability that the third entity needs to have includes situational awareness. In this case, the second entity may determine that the first configuration information does not meet the security policy, and the first configuration information fails to be registered.

In some possible implementations, after S505, the method shown in FIG. 5 further includes:

S506: The second entity sends fifth information to the first entity, and correspondingly, the first entity receives the fifth information from the second entity. The fifth information indicates whether the first configuration information of the first entity is successfully registered.

Case 1: The fifth information indicates that the first configuration information of the first entity is successfully registered. In this case, in S502, the first feedback information indicates that the first entity is successfully configured with the first configuration information. In this way, the third entity can learn that the first configuration information of the first entity has been successfully registered, so that the first entity can be invoked to provide the security capability corresponding to the first configuration information.

Case 2: The fifth information indicates that the first configuration information of the first entity fails to be registered. The following describes operations of each entity in Case 2.

In an example, the fifth information may include indication information of a security capability #B, the security capability #B is a security capability that the third entity needs to have in the security policy, and a capability provided by the first entity based on the first configuration information does not include the security capability #B. The first entity may reconfigure the first entity based on the security capability #B. For a configuration manner, refer to S501. Details are not described herein again. The first entity may then perform the operations in S503 and S504 again until the configuration information of the first entity is successfully registered.

In another example, in S502, the first feedback information may indicate that the first configuration information fails to be registered. In this way, the third entity can learn that the first configuration information fails to be registered, and may perform a further operation on the first entity. For example, the fifth information and the first feedback information include indication information of a security capability #B, the security capability #B is a security capability that the third entity needs to have in the security policy, and a capability provided by the first entity based on the first configuration information does not include the security capability #B. The third entity may reconfigure the first entity based on the security capability #B. For a configuration manner, refer to S501. Details are not described herein again.

It should be understood that the fifth information may be response information of the fourth information, or may be a notification message indicating whether the first configuration information is successfully registered.

According to the method, the first entity can learn in time whether the first configuration information is successfully registered, to provide, for the third entity based on a registration result, a security capability allowed by the second entity.

To resolve the foregoing problems, an embodiment of this application provides another communication method. The method may be applied to the communication system shown in FIG. 1. The following describes a procedure of the method in detail with reference to a flowchart shown in FIG. 6.

S601: A third entity sends request information to a second entity, and correspondingly, the second entity receives the request information from the third entity. The request information is used to request to set up a first entity, and the first entity is an entity that provides a security capability for the third entity.

Optionally, when the third entity generates a security requirement of the third entity, and there is no first entity currently, the third entity may send the request information to the second entity. For specific content of generating the security requirement of the third entity by the third entity, refer to Scenario 2 in S501. Details are not described herein again. The first entity may be a logical function.

In some possible implementations, the request information includes indication information of a security capability module in the first entity. In other words, the request information includes indication information of a security capability module corresponding to a security capability that the third entity needs to have. The indication information of the security capability module is, for example, a name of the security capability module. For example, in the security requirement of the third entity, the security capability that the third entity needs to have includes blockchain and trusted measurement. In this case, names of security capability modules in the request information include blockchain and trusted measurement. In this way, content of the first entity can be accurately indicated, so that a speed of setting up the first entity can be increased.

S602: The second entity sends second feedback information to the third entity, and correspondingly, the third entity receives the second feedback information from the second entity.

The second feedback information indicates information for setting up the first entity.

In some examples, the second feedback information includes a download address of the first entity. An apparatus (for example, a first server) corresponding to the download address may include the security capability module in the first entity. In this way, after the second feedback information is received, the third entity may download the security capability module in the first entity from the apparatus corresponding to the download address. In addition, the second feedback information includes a small amount of information, so that signaling overheads can be reduced.

In some other examples, the second feedback information includes code of the security capability module in the first entity. In this way, after the second feedback information is received, the second entity may obtain the security capability module in the first entity, so that the first entity can be quickly set up.

It should be understood that the second feedback information may be response information of the request information, or may be a notification message indicating the information for setting up the first entity.

Optionally, before sending the second feedback information, the second entity determines whether the third entity is authenticated, and the second entity sends the second feedback information only when the third entity is authenticated. In some examples, the second entity may perform authentication on the third entity, to determine whether the third entity is authenticated. In some other examples, a core network device (for example, an authentication server function (AUSF) or a UDM) may perform authentication on the third entity, and send an authentication result to the second entity. The second entity determines, based on the authentication result, whether the third entity is authenticated. A specific authentication process is not limited in this application.

S603: The third entity sets up the first entity based on the second feedback information.

In some implementations, the third entity may obtain security capability modules in the first entity based on the second feedback information. For an obtaining method, refer to S602.

Details are not described herein again. The third entity may then set up the first entity including these security capability modules.

In some other implementations, the third entity may obtain security capability modules in the first entity based on the second feedback information. For an obtaining method, refer to S602. Details are not described herein again. The third entity may then send the security capability modules in the first entity to a fifth entity configured to set up the first entity. The fifth entity may set up the first entity including these security capability modules. The fifth entity is, for example, an apparatus in which the first entity is located.

Optionally, after the first entity is set up, the first entity may generate first configuration information. For a manner in which the first entity generates the first configuration information, refer to S501. Details are not described herein again.

S604: The first entity sends sixth information to the second entity, and correspondingly, the second entity receives the sixth information from the first entity. The sixth information includes the first configuration information of the first entity, and the sixth information indicates whether the first entity is successfully configured with the first configuration information. In this way, the second entity can obtain and store the first configuration information, to manage the first entity.

According to the method shown in FIG. 6, when the first entity does not exist, the third entity may request the second entity to set up the first entity based on a requirement of the third entity, so that the first entity can be quickly and flexibly set up. In addition, the first entity may be set up by using signaling. Therefore, when the third entity perceives a change in an application scenario, the third entity may request the second entity in time to set up the first entity, so that the setup of the first entity meets a current requirement, and reliable security support is provided for the third entity. In addition, in the method, the third entity, as a security capability demander, may trigger the setup of the first entity. This improves a capability of the third entity to control the first entity serving as a security function, so that the first entity can provide a security service for the third entity as required. In addition, in the method, the first entity may be an entity independent of the third entity, the first entity may serve as a security function, and the third entity may serve as a communication function, so that the security function independent of the communication function can be flexibly set up, thereby facilitating independent evolution, update, and upgrade of the security function.

In some possible implementations, the method shown in FIG. 6 further includes:

S605: The second entity sends seventh information to the third entity, and correspondingly, the third entity receives the seventh information from the second entity.

The seventh information indicates a second security capability, and the second security capability is a security capability of the first entity. For example, after the first entity is set up, security capabilities provided by the first entity for the third entity include encryption and authentication. The second security capability includes encryption and authentication. In this way, the second entity can notify the third entity in time of the second security capability that can be provided by the first entity, so that the third entity invokes the first entity to support the second security capability.

For example, the seventh information includes indication information of the second security capability and identification information of the first entity. For specific content of the second security capability, refer to the indication information of the first security capability in S502. Details are not described herein again.

Optionally, before S605, the second entity may perform verification on the first configuration information, for example, verify whether the first configuration information meets a security policy. For specific verification content, refer to S505. Details are not described herein again. When it is verified by the second entity that the first configuration information meets the security policy, the second entity may perform S605. When it is verified by the second entity that the first configuration information does not meet the security policy, the first entity may be reconfigured. For a configuration manner, refer to S501. Details are not described herein again.

In some possible implementations, the method shown in FIG. 6 may be combined with the method shown in FIG. 5. For example, after the first entity is set up by using the method shown in FIG. 6, the first entity may be configured by using the method shown in FIG. 5.

An embodiment of this application provides still another communication method. The method is a method for setting up a first entity, and is a possible implementation of the method shown in FIG. 5. The following describes a procedure of the method in detail by using an example in which a first entity is a gear, a second entity is an engine, and a third entity is a demander.

For ease of understanding the method, the following first describes setup of the gear.

The setup of the gear may also be referred to as activation of the gear. When the gear is set up in a local configuration manner, the gear enters the configured state from the ready state, some enabler modules in the gear enter the configured state, and the other enabler modules enter the disabled state. When the gear is set up in a remote download manner, the gear enters the configured state, and the enabler modules in the gear also enter the configured state.

In this application, a gear setup method may be a gear setup method triggered by the engine, or a gear setup method triggered by the demander. Descriptions are separately provided below.

FIG. 7 shows the gear setup method triggered by the engine. In the method, a fourth entity is the engine. The following describes the method with reference to FIG. 7.

S701: The engine sends first information to the gear, where the first information may be used to set up the gear.

For specific content of S701, refer to Implementation 1, Implementation 2, and Implementation 4 in S501. Details are not described again.

The following uses an example to describe a condition for sending the first information by the engine.

In some examples, when determining that the demander is in a configuration phase or the demander newly joins a network, the engine may send the first information to the gear. In other words, a gear setup process may occur in the configuration phase of the demander. The demander is, for example, a terminal device, a base station, or an NF. For example, the engine may detect, through a network topology, that the demander newly joins the network. For example, if it is displayed in the network topology that a terminal device #1 is newly added to the network, the engine may determine that a gear bound to the terminal device #1 needs to be set up. Alternatively, after receiving a network access request of the demander and determining that the demander is authenticated, the engine may determine to set up the gear for the demander.

In some other examples, the engine may send the first information to the gear when determining that at least one of the following conditions is met: a network evolves from 5G to 6G and/or is compatible with 6G; a network is upgraded to 6G online; an operator has configured the gear, but does not bind the demander to the gear; or the operator has bound the gear to the demander, but has not activated the gear.

In still some examples, the engine may send the first information to the gear after receiving an instruction that is delivered by a management plane or a management network element and that instructs to set up the gear. Optionally, the instruction that instructs to set up the gear includes the first information.

The following describes the first information with reference to Implementation a1 to Implementation a3.

In Implementation a1, the first information includes a first parameter used to perform a setup operation on the gear. For specific content of this implementation, refer to Implementation 1 in S501. Details are not described again.

For example, the first parameter includes a type of a management operation performed on the gear, an expected state of the gear, and a name of an enabler module that is in the gear and on which the management operation is to be performed. For example, the first parameter includes management type=setup, expected state=configured, [enabler name=blockchain]. This indicates that the type of the management operation performed on the gear is setup, the expected state of the gear is a configured state, and the gear includes the enabler module whose name is blockchain, that is, an expected state of the enabler module whose name is blockchain is the configured state.

The first parameter may be determined by the engine based on a security policy. For example, the security policy is that security capabilities that all nodes need to have include blockchain. If there is no gear profile of the gear in the engine, the engine may determine that the first parameter includes management type=setup, expected state-configured, [enabler name=blockchain].

In Implementation a2, the first information includes a security policy. For specific content of this implementation, refer to Implementation 2 in S501. For specific content of the first parameter, refer to Implementation a1. Details are not described again.

Optionally, after receiving the security policy, the gear may determine, based on the security policy, a first parameter used to perform a setup operation on the gear. For example, the security policy is that security capabilities that all nodes need to have include blockchain. The gear has been bound to the demander, but the gear has not been activated. In this case, the gear may determine that the first parameter includes management type=setup, expected state=configured, [enabler name=blockchain].

In Implementation a3, the first information includes first configuration information. For specific content of this implementation, refer to Implementation 4 in S501. Details are not described again.

For example, the first configuration information is a gear profile #1. In the gear profile #1, a state of the gear is a configured state, an ID of a node bound to the gear is an ID of the demander, and a name of an enabler module is blockchain.

The first configuration information may be determined by the engine based on a security policy. For example, the security policy is that security capabilities that all nodes need to have include blockchain. If the engine does not have a gear profile of the gear bound to the demander, the engine may determine that the first configuration information of the gear is the gear profile #1. In the gear profile #1, a state of the gear is a configured state, an ID of a node bound to the gear is an ID of the demander, and a name of an enabler module is blockchain.

S702: The gear performs a gear setup operation.

In Implementation b1, the gear may set up the gear based on a first parameter. For example, the first parameter includes management type-setup, expected state-configured, [enabler name=blockchain]. If the gear includes an enabler module whose name is blockchain, the gear may set up the gear in a local configuration manner, for example, transition a state of the gear to the configured state, and transition a state of the enabler module whose name is blockchain to the configured state. If the gear does not include an enabler module whose name is blockchain, the gear may set up the gear in a remote download manner. For example, the gear downloads the enabler module whose name is blockchain from a first server, transitions a state of the gear to the configured state, and transitions a state of the enabler module whose name is blockchain to the configured state.

In Implementation b2, the gear may set up the gear based on first configuration information. For example, in the first configuration information, a state of the gear is the configured state, an ID of a node bound to the gear is an ID of the demander, and a name of an enabler module is blockchain. The gear may set up the gear in a manner similar to that in Implementation b1. Details are not described herein again.

S703: The gear generates first configuration information corresponding to a current configuration. For specific content of the first configuration information, refer to Implementation a3 in S701. Details are not described herein again.

S703 is an optional step. For example, when the first information includes the first configuration information, the method shown in FIG. 7 may not include S703.

S704: The gear sends second information to the demander. The second information indicates a first security capability provided by the gear for the demander, and the first security capability is determined based on the first information.

For specific content of S704, refer to S503. Details are not described again.

Optionally, because the gear is newly set up, the first security capability is all security capabilities provided by the gear for the demander. For example, if a security capability that can be provided by the gear includes blockchain, the first security capability includes blockchain.

S705: The demander verifies whether the first security capability meets a requirement of the demander. If the first security capability can meet the requirement of the demander, the demander can store the first security capability.

For specific content of verifying, by the demander, whether the first security capability meets the requirement of the demander, refer to the descriptions of verifying, by the third entity, whether the first security capability meets the requirement of the third entity in S503. Details are not described herein again.

S706: The demander sends third information to the gear. The third information indicates whether the first security capability meets the requirement of the demander.

For specific content of S706, refer to S504. Details are not described herein again.

S707: The gear sends first feedback information to the engine. The first feedback information indicates whether the gear is successfully configured with the first configuration information. In other words, the first feedback information indicates whether the gear is successfully set up.

For specific content of S707, refer to S502. Details are not described again.

S708: The engine stores the first configuration information.

Optionally, in the method shown in FIG. 7, S701 may be replaced with: The engine sends first information to a node on which the gear is located. The first information may be the first information in Implementation a1 or Implementation a2. S702 may be replaced with: The node on which the gear is located performs a gear setup operation. For specific content of performing the gear setup operation by the node on which the gear is located, refer to the remote download manner in the gear setup operation performed by the gear. Details are not described herein again.

According to the method shown in FIG. 7, the engine can trigger the setup of the gear based on the first information, so that the gear can be quickly and flexibly set up. In addition, the engine may trigger the setup of the gear by using signaling. Therefore, when the engine perceives a change in an application scenario, the engine may trigger the setup of the gear in time, so that the gear can meet a current requirement, and reliable security support is provided for the demander. In addition, in the method, the gear may be an entity independent of the demander, the gear may serve as a security function, and the demander may serve as a communication function, so that the security function independent of the communication function can be flexibly set up, thereby facilitating independent evolution, update, and upgrade of the security function.

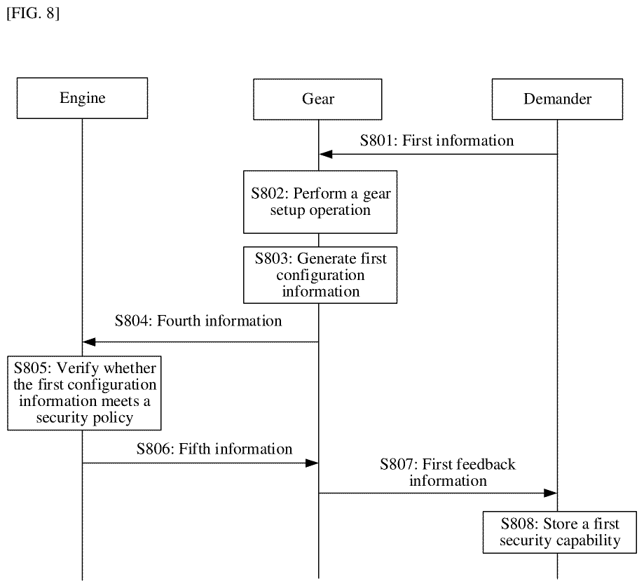

FIG. 8 shows the gear setup method triggered by the demander. In the method, a fourth entity is the demander, and the demander has been bound to a default gear, but the gear is not activated. The following describes the method with reference to FIG. 8.

S801: The demander sends first information to the gear.

For specific content of S801, refer to Implementation 1 and Implementation 3 in S501. Details are not described again.

The following uses an example to describe a condition for sending the first information by the demander.

In some examples, when determining that the demander is in a configuration stage, the demander may send the first information to the gear. In other words, a gear setup process may occur in the configuration phase of the demander. The demander is, for example, a terminal device, a base station, or an NF.

In some other examples, the demander may send the first information to the gear when determining that at least one of the following conditions is met: the demander changes from needing to have a 5G security capability to needing to have a 5G security capability and a 6G security capability; or an operator binds the first entity to the third entity, but has not activated the first entity.

In still some examples, the engine may send the first information to the gear after receiving an instruction that is delivered by a management plane or a management network element and that is used to set up the gear. Optionally, the instruction used to set up the gear may include the first information.

The following describes the first information.

In a possible implementation, the first information includes a first parameter used to perform a setup operation on the gear. For specific content of this implementation, refer to Implementation 1 in S501. For specific content of the first parameter, refer to Implementation a1 in S701. Details are not described again.

The first parameter may be determined by the demander based on a security requirement of the demander. For example, the security requirement is that a security capability that the demander needs to have includes blockchain. If the demander has been bound to the gear, but the demander does not have a security capability of the gear, the demander may determine that the first parameter includes: management type-setup, expected state=configured, [enabler name=blockchain].

In another possible implementation, the first information includes a security requirement of the demander. For specific content of this implementation, refer to Implementation 3 in S501. Details are not described again.

Optionally, after receiving the security requirement, the gear may determine, based on the security requirement, a first parameter used to perform a setup operation on the gear. For example, the security requirement is that a security capability that the demander needs to have includes blockchain. If the gear has been bound to the demander, but the gear has not been activated, the demander may determine that the first parameter includes management type=setup, expected state=configured, [enabler name=blockchain]. S802: The gear performs a gear setup operation.

For specific content of S802, refer to S702. Details are not described herein again.

S803: The gear generates first configuration information corresponding to a current configuration. For specific content of the first configuration information, refer to Implementation a3 in S701. Details are not described herein again.

S804: The gear sends fourth information to the engine. The fourth information includes the first configuration information, and the fourth information is used to register the first configuration information.

For specific content of S804, refer to S505. Details are not described herein again.

S805: The engine verifies whether the first configuration information meets a security policy. If the first configuration information can meet the security policy, the engine may store the first configuration information.

For specific content of S805, refer to S505. Details are not described herein again.

S806: The engine sends fifth information to the gear. The fifth information indicates whether the first configuration information is successfully registered.

For specific content of S806, refer to S506. Details are not described herein again.

S807: The gear sends first feedback information to the demander. The first feedback information may include indication information of a first security capability and an ID of the gear.

For specific content of S807, refer to S502. Details are not described herein again.

S808: The demander stores the first security capability.

According to the method shown in FIG. 8, the demander can trigger the setup of the gear based on the first information, so that the gear can be quickly and flexibly set up. In addition, the demander may trigger the setup of the gear by using signaling. Therefore, when the demander perceives a change in an application scenario, the demander may trigger the setup of the gear in time, so that the gear can meet a current requirement. In addition, in the method, the demander can trigger the setup of the gear. This improves a capability of the demander to control the gear serving as a security function, so that the gear can provide a security service for the demander as required. In addition, in the method, the gear may be an entity independent of the demander, the gear may serve as a security function, and the demander may serve as a communication function, so that the security function independent of the communication function can be flexibly set up, thereby facilitating independent evolution, update, and upgrade of the security function.

An embodiment of this application provides yet another communication method. The method is a method for updating a first entity, and is another possible implementation of the method shown in FIG. 5. The following describes a procedure of the method in detail by using an example in which a first entity is a gear, a second entity is an engine, and a third entity is a demander.

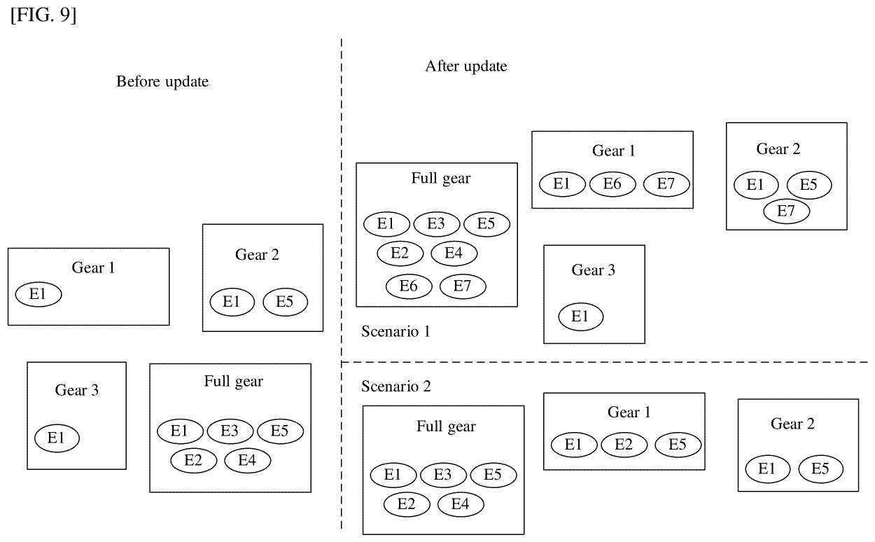

For ease of understanding the method, the following first describes a gear update scenario. FIG. 9 shows two gear update scenarios. The following provides descriptions with reference to FIG. 9.

Scenario 1: Upgrade or version evolution is performed on gears in an entire network. For example, as shown in FIG. 9, enabler modules in a network before update may include E1 to E5, and E6 and E7 are newly added to the enabler modules in a network after the update. The engine may trigger update of each gear, for example, trigger addition of E6 and E7 to a gear 1, and trigger addition of E7 to a gear 2.

Scenario 2: A gear needs to be updated because a security policy of a network or a security requirement of the demander changes. For specific content of the security policy and the security requirement, refer to S501. Details are not described herein again. For example, as shown in FIG. 9, before and after the update, enabler modules in a full gear remain unchanged, and are E1 to E5. Before the update, the enabler module in the gear 1 is E1, and after the update, E2 and E5 are added to the enabler module in the gear 1.

In this application, a gear update method may be a gear update method triggered by the engine, or a gear update method triggered by the demander. The gear update method triggered by the engine may be applied to Scenario 1 and Scenario 2 above, and the gear update method triggered by the demander may be applied to Scenario 2 above.

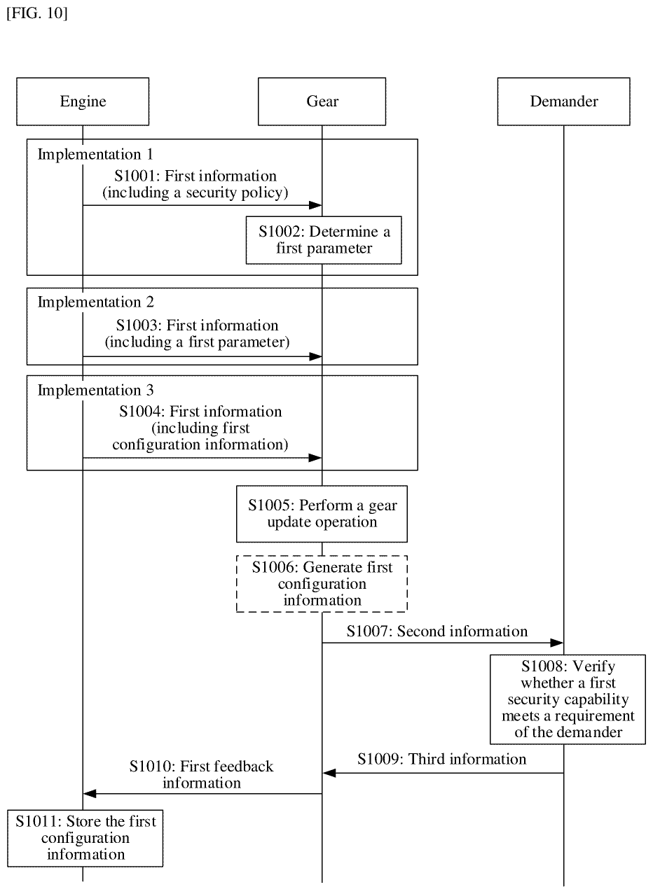

FIG. 10 shows the gear update method triggered by the engine. In the method, a fourth entity is the engine. The following describes the method with reference to FIG. 10.

In Implementation 1, the method shown in FIG. 10 includes S1001 and S1002.

S1001: The engine sends first information including a security policy to the gear, and correspondingly, the gear receives the first message.

S1002: The gear determines, based on the security policy, a first parameter used to perform an update operation on the gear.

For specific content of S1001 and S1002, refer to Implementation 2 in S501. Details are not described again.

In this application, the update of the gear may include at least one of the following: state transition of the gear between a configured state and a disabled state, state transition of an enabler module, addition or deletion of an enabler module, change of the demander bound to the gear, or activation, disabling, addition, or deletion of an algorithm in an enabler module. For the state transition of the enabler, refer to the term explanation part. Details are not described herein again. Correspondingly, a gear update object may include at least one of the following: the gear, the enabler module in the gear, or the algorithm in the enabler module. The following separately describes a first parameter corresponding to each update object.

1. The update object is the gear.

If the gear determines to perform state transition between the configured state and the disabled state on the gear, a state of the gear in a gear profile needs to be changed. For example, the first parameter includes management type=update, expected state=disabled. This indicates that a type of a management operation performed on the gear is update, and an expected state of the gear is the disabled state. For another example, the first parameter includes management type=update, expected state=configured. This indicates that a type of a management operation performed on the gear is update, and an expected state of the gear is the configured state.

The gear determines to change the demander bound to the gear. For example, if a node bound to the gear has been deleted or restarted, but the gear is not deleted synchronously, the gear may be further bound to another node. In this case, the gear may determine to change an ID of the demander in the gear profile. For example, the first parameter may include management type=update, node ID=ID #A. This indicates that a type of a management operation performed on the gear is update, and a node bound to the gear is changed to a node whose ID is ID #A.

In this application, the gear may update the update object being the gear in a local configuration manner.

2. The update object is the enabler module.

If the gear determines to perform state transition on the enabler module, or add or delete the enabler module in the gear, the gear needs to change one or more of a name of the enabler module in the gear profile, an algorithm identifier in an enabler corresponding to the enabler module, or a state of the enabler module. For example, the first parameter includes management type-update, [enabler names-blockchain, expected enabler state=terminated]. This indicates that a type of a management operation performed on the gear is update, and an enabler module whose name is blockchain is expected to be deleted. The square brackets may include names of one or more enabler modules and corresponding information (for example, an expected state of an enabler module).

In this application, the gear may update the update object being the enabler module in a local configuration or remote download manner.

3. The update object is the algorithm in the enabler module.

If the gear determines to activate, disable, add, or delete the algorithm in the enabler module, an ID and/or a state of the algorithm in the gear profile need/needs to be changed. For example, the first parameter includes management type=update, [enabler name-blockchain, algorithm ID=ID #B, expected algorithm state=configured]. This indicates that a type of a management operation performed on the gear is update, and an algorithm whose identifier is ID #B in an enabler module whose name is blockchain is expected to be activated.

In this application, the gear may update the update object being the algorithm in a local configuration or remote download manner.

In Implementation 2, the method shown in FIG. 10 includes S1003.

S1003: The engine sends first information including a first parameter to the gear.

For specific content of S1003, refer to Implementation 1 in S501. For content of the first parameter, refer to S1002. Details are not described again.

Optionally, after the engine obtains a security policy, or after the engine receives an instruction that is sent by a management plane or another network element and that instructs to update the gear, the engine may send the first information to the gear. The instruction that instructs to update the gear may include the first information.

In Implementation 3, the method shown in FIG. 10 includes S1004.

S1004: The engine sends first information including first configuration information to the gear.

For specific content of S1004, refer to Implementation 4 in S501. Details are not described herein again.

After S1002, S1003, or S1004, the method shown in FIG. 10 further includes: S1005: The gear performs a gear update operation.

In Implementation c1, the gear may update the gear based on a first parameter. For example, the first parameter includes management type=update, [enabler names=blockchain, expected enabler state-configured]. If the gear includes an enabler module whose name is blockchain, the gear may update the gear in a local configuration manner, for example, transition a state of the enabler module whose name is blockchain from another state to the configured state. If the gear does not include an enabler module whose name is blockchain, the gear may update the gear in a remote download manner. For example, the gear downloads the enabler module whose name is blockchain from a first server, and transitions a state of the enabler module whose name is blockchain to the configured state.

In Implementation c2, the gear may update the gear based on first configuration information.

For example, the first configuration information is a gear profile #2. In the gear profile #2, a state of the gear is the configured state. If the current state of the gear is the disabled state, the gear transitions the state of the gear to the configured state.

For another example, the first configuration information is a gear profile #3. In the gear profile #3, a state of the gear is the configured state, a name of an enabler module is blockchain, and a state of the enabler module whose name is blockchain is the configured state. If the gear includes an enabler module whose name is blockchain, the gear may update the gear in a local configuration manner, for example, transition a state of the enabler module whose name is blockchain from another state to the configured state. If the gear does not include an enabler module whose name is blockchain, the gear may update the gear in a remote download manner. For example, the gear downloads the enabler module whose name is blockchain from a first server, and transitions a state of the enabler module whose name is blockchain to the configured state.

S1006: The gear generates first configuration information corresponding to a current configuration. For specific content of the first configuration information, refer to S1005. Details are not described herein again.

S1006 is an optional step. For example, when the first information includes the first configuration information, the method shown in FIG. 10 may not include S1006.

S1007: The gear sends second information to the demander. The second information indicates a first security capability provided by the gear for the demander, and the first security capability is determined based on the first information.

S1008: The demander verifies whether the first security capability meets a requirement of the demander. If the first security capability can meet the requirement of the demander, the demander can store the first security capability.

For specific content of S1007 and S1008, refer to S503. Details are not described herein again.

S1009: The demander sends third information to the gear. The third information indicates whether the first security capability meets the requirement of the demander.

For specific content of S1009, refer to S504. Details are not described herein again.

S1010: The gear sends first feedback information to the engine. The first feedback information indicates whether the gear is successfully configured with the first configuration information. In other words, the first feedback information indicates whether the gear is successfully updated.

For specific content of S1010, refer to S502. Details are not described again.

S1011: The engine stores the first configuration information.

According to the method shown in FIG. 10, the engine can trigger the update of the gear based on the first information, so that the gear can be quickly and flexibly updated. In addition, the engine may trigger the update of the gear by using signaling. Therefore, when the engine perceives a change in an application scenario, the engine may trigger the update of the gear in time, so that the gear can meet a current requirement, and reliable security support is provided for the demander. In addition, in the method, the gear may be an entity independent of the demander, the gear may serve as a security function, and the demander may serve as a communication function, so that the security function independent of the communication function can be flexibly updated, thereby facilitating independent evolution, update, and upgrade of the security function.

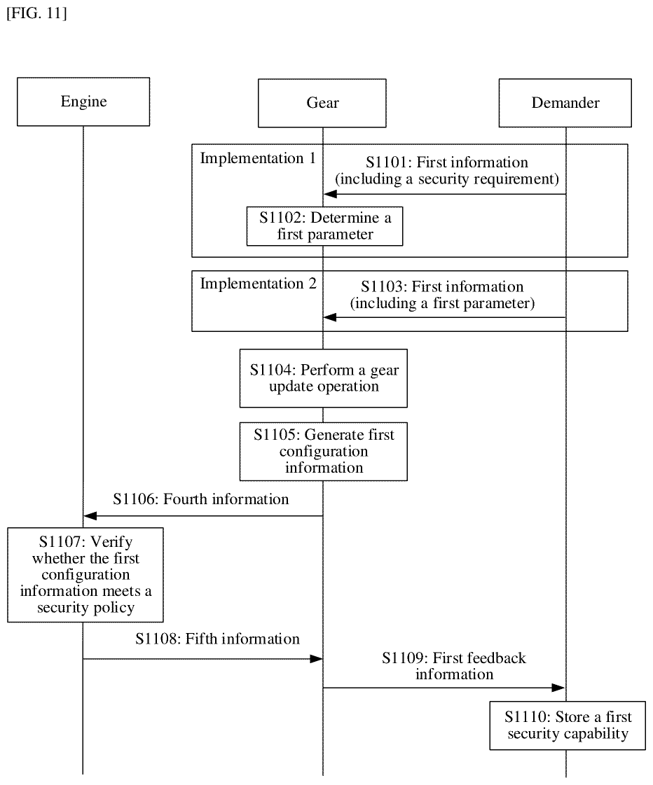

FIG. 11 shows the gear update method triggered by the demander. In the method, a fourth entity is the demander. The following describes the method with reference to FIG. 11.

In Implementation 1, the method shown in FIG. 11 further includes S1101 and S1102.

S1101: The demander sends first information including a security requirement to the gear.

S1102: The gear determines, based on the security requirement, a first parameter used to perform an update operation on the gear.

For specific content of S1101 and S1102, refer to Implementation 3 in S501. For specific content of the first parameter, refer to S1002. Details are not described herein again.

In Implementation 2, the method shown in FIG. 11 includes S1103.

S1103: The demander sends first information including a first parameter to the gear.

For specific content of S1103, refer to Implementation 1 in S501. For specific content of the first parameter, refer to S1002. Details are not described herein again.

After S1102 or S1103, the method shown in FIG. 11 further includes the following steps.

S1104: The gear performs a gear update operation.

The gear may update the gear based on the first parameter. For specific content, refer to S1005. Details are not described herein again.

S1105: The gear generates first configuration information corresponding to a current configuration. For specific content of the first configuration information, refer to S1005. Details are not described herein again.

S1106: The gear sends fourth information to the engine. The fourth information includes the first configuration information, and the fourth information is used to register the first configuration information.

S1107: The engine verifies whether the first configuration information meets a security policy. If the first configuration information can meet the security policy, the engine may store the first configuration information.

For specific content of S1106 and S1107, refer to S505. Details are not described herein again.

S1108: The engine sends fifth information to the gear. The fifth information indicates whether the first configuration information is successfully registered.

For specific content of S1108, refer to S506. Details are not described herein again.

S1109: The gear sends first feedback information to the demander. The first feedback information may include indication information of a first security capability and an ID of the gear.

For specific content of S1109, refer to S502. Details are not described herein again.

S1110: The demander stores the first security capability.

According to the method shown in FIG. 11, the demander can trigger the update of the gear based on the first information, so that the gear can be quickly and flexibly updated. In addition, the demander may trigger the update of the gear by using signaling. Therefore, when the demander perceives a change in an application scenario, the demander may trigger the update of the gear in time, so that the gear can meet a current requirement. In addition, in the method, the demander can trigger the update of the gear. This improves a capability of the demander to control the gear serving as a security function, so that the gear can provide a security service for the demander as required. In addition, in the method, the gear may be an entity independent of the demander, the gear may serve as a security function, and the demander may serve as a communication function, so that the security function independent of the communication function can be flexibly updated, thereby facilitating independent evolution, update, and upgrade of the security function.

An embodiment of this application provides yet another communication method. The method is a method for locking or unlocking a first entity, and is still another possible implementation of the method shown in FIG. 5. The following describes a procedure of the method in detail by using an example in which a first entity is a gear, a second entity is an engine, and a third entity is a demander.

In this application, a gear lock or unlock method may be a gear lock or unlock method triggered by the engine, or a gear lock or unlock method triggered by the demander. Descriptions are separately provided below.

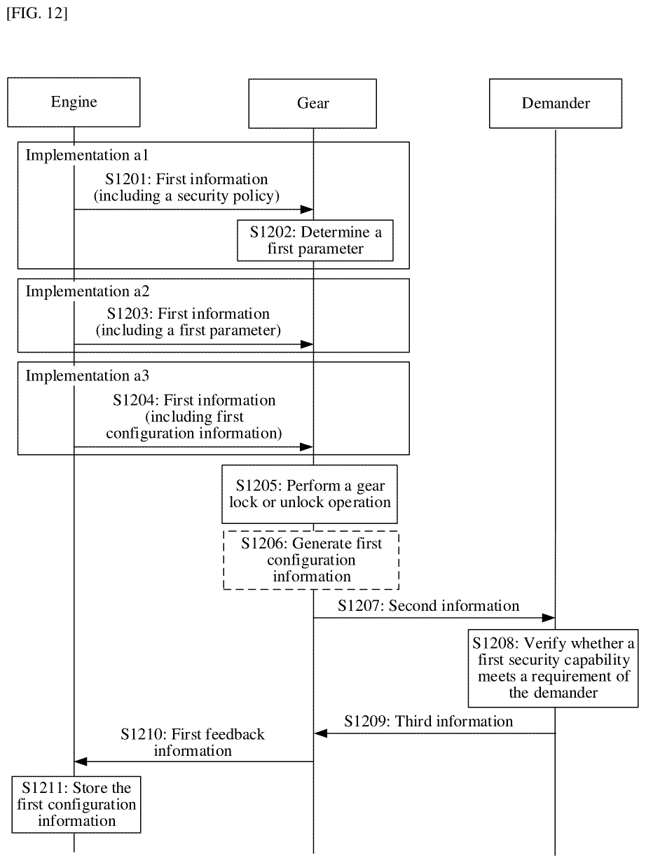

FIG. 12 shows the gear lock or unlock method triggered by the engine. In the method, a fourth entity is the engine. The following describes the method with reference to FIG. 12.

In Implementation a1, the method shown in FIG. 12 includes S1201 and S1202.

S1201: The engine sends first information including a security policy to the gear.

S1202: The gear determines, based on the security policy, a first parameter used to perform a lock or unlock operation on the gear.

For specific content of S1201 and S1202, refer to Implementation 2 in S501. Details are not described again.

In this application, the lock or unlock of the gear may include at least one of the following: state transition of the gear between a configured state and a locked state, or state transition of an enabler module between a configured state and a locked state. Correspondingly, a gear lock or unlock object may include at least one of the following: the gear or the enabler module in the gear. The following separately describes a first parameter corresponding to each lock or unlock object.

1. The lock or unlock object is the gear.

If the gear determines to perform state transition between the configured state and the locked state on the gear, a state of the gear in a gear profile needs to be changed.

In some examples, the gear determines to transition the gear from the configured state to the locked state. In this case, the first parameter may include: management type=lock, and/or expected state=locked. This indicates that a type of a management operation performed on the gear is lock, and/or an expected state of the gear is the locked state.

In some other examples, the gear determines to transition the gear from the locked state to the configured state. In this case, the first parameter may include: management type=unlock, and/or expected state-configured. This indicates that a type of a management operation performed on the gear is unlock, and/or an expected state of the gear is the configured state.

In this application, the gear may lock or unlock the gear in a local configuration manner.

2. The lock or unlock object is the enabler module.

If the gear determines to perform state transition between the configured state and the locked state on the enabler module, a state of the enabler module in a gear profile needs to be changed.

In some examples, the gear determines to transition the enabler module in the gear from the configured state to the locked state. In this case, the first parameter may include management type=lock, [enabler names=blockchain]; or [enabler names-blockchain, expect enabler state=locked]. This indicates that a lock operation is performed on an enabler module whose name is blockchain in the gear.

In some other examples, a management operation on the gear is to transition the enabler module in the gear from the locked state to the configured state. In this case, the first parameter may include management type=unlock, [enabler names-blockchain]; or [enabler names=blockchain, expect enabler state=configured]. This indicates that an unlock operation is performed on an enabler module whose name is blockchain in the gear.

In this application, the gear may lock or unlock the enabler module in a local configuration or remote download manner.

In Implementation a2, the method shown in FIG. 12 includes S1203.

S1203: The engine sends first information including a first parameter to the gear.

For specific content of S1203, refer to Implementation 1 in S501. For content of the first parameter, refer to S1202. Details are not described again.

Optionally, after the engine obtains a security policy, or after the engine receives an instruction that is sent by a management plane or another network element and that instructs to lock or unlock the gear, the engine may send the first information to the gear. The instruction that instructs to lock or unlock the gear may include the first information.

In Implementation a3, the method shown in FIG. 12 includes S1204.

S1204: The engine sends first information including first configuration information to the gear.

For specific content of S1204, refer to Implementation 4 in S501. Details are not described herein again.

After S1202, S1203, or S1204, the method shown in FIG. 12 further includes:

S1205: The gear performs a gear lock or unlock operation.

In Implementation d1, the gear may perform the gear lock or unlock operation based on a first parameter.

For example, the first parameter includes management type=lock, [enabler names=blockchain]; or [enabler names-blockchain, expect enabler state=locked]. The gear may perform a lock operation on an enabler module whose name is blockchain, that is, change a state of the enabler module whose name is blockchain to the locked state.

For another example, the first parameter includes: management type=lock, and/or expected state=locked. The gear may perform a lock operation on the gear, that is, transition a state of the gear to the locked state.

For another example, the first parameter includes: management type=unlock, and/or expected state=configured. The gear may perform an unlock operation on the gear, that is, transition a state of the gear to the configured state.

In Implementation d2, the gear may perform the gear lock or unlock operation based on first configuration information.

For example, the first configuration information is a gear profile #4. In the gear profile #4, a state of the gear is the configured state. A current state of the gear is the locked state. In this case, the gear may perform an unlock operation on the gear, that is, transition the state of the gear to the configured state.

For another example, the first configuration information is a gear profile #5. In the gear profile #5, a state of the gear is the locked state. A current state of the gear is the configured state. In this case, the gear may perform a lock operation on the gear, that is, transition the state of the gear to the locked state.

S1206: The gear generates first configuration information corresponding to a current configuration. For specific content of the first configuration information, refer to S1205. Details are not described herein again.

S1207: The gear sends second information to the demander. The second information indicates a first security capability provided by the gear for the demander, and the first security capability is determined based on the first information.

S1208: The demander verifies whether the first security capability meets a requirement of the demander. If the first security capability can meet the requirement of the demander, the demander can store the first security capability.

S1209: The demander sends third information to the gear. The third information indicates whether the first security capability meets the requirement of the demander.

S1210: The gear sends first feedback information to the engine. The first feedback information indicates whether the gear is successfully configured with the first configuration information. In other words, the first feedback information indicates whether the gear is successfully locked or unlocked.

S1211: The engine stores the first configuration information.

For specific content of S1206 to S1211, refer to S1006 to S1011. Details are not described again.

According to the method shown in FIG. 12, the engine can trigger the lock or unlock of the gear based on the first information, so that the gear can be quickly and flexibly locked or unlocked. In addition, the engine may trigger the lock or unlock of the gear by using signaling. Therefore, when the engine perceives a change in an application scenario, the engine may trigger the lock or unlock of the gear in time, so that the gear can meet a current requirement, and reliable security support is provided for the demander. In addition, in the method, the gear may be an entity independent of the demander, the gear may serve as a security function, and the demander may serve as a communication function, so that the security function independent of the communication function can be flexibly locked or unlocked, thereby facilitating independent evolution, update, and upgrade of the security function.

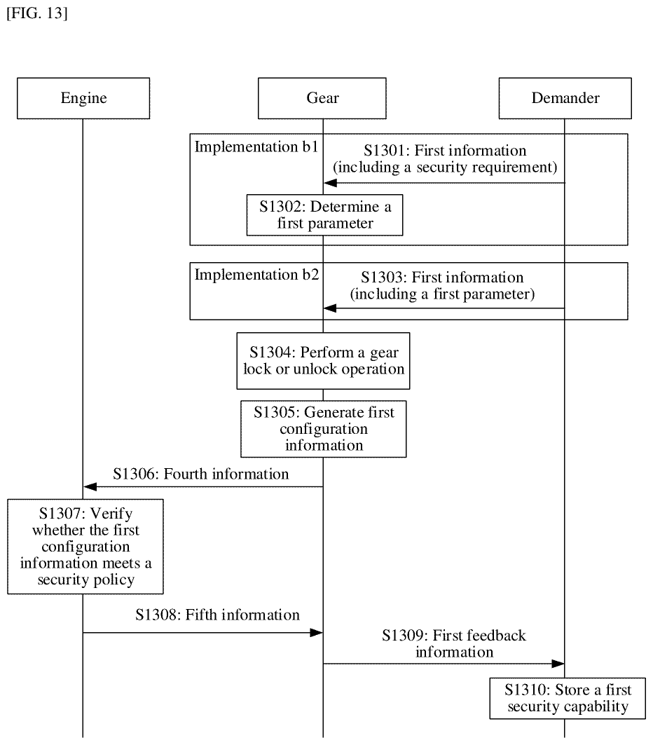

FIG. 13 shows the gear lock or unlock method triggered by the demander. In the method, a fourth entity is the demander. The following describes the method with reference to FIG. 13.

In Implementation b1, the method shown in FIG. 13 includes S1301 and S1302.

S1301: The demander sends first information including a security requirement to the gear.

For specific content of S1301, refer to Implementation 3 in S501. Details are not described again.

In some examples, the security requirement indicates that the demander needs to have a security capability that can be provided by the gear, and the demander may trigger lock of the gear, to send the first information. When the security requirement indicates that the demander needs to have the security capability that can be provided by the gear, the demander may be invoking the gear, or may invoke the gear in a subsequent communication process.

In some other examples, the security requirement indicates that the demander needs to have a security capability that can be provided by an enabler module in the gear, and the demander may trigger lock of the enabler module, to send the first information. When the security requirement indicates that the demander needs to have the security capability that can be provided by the enabler module, the demander may be invoking the enabler module, or may invoke the enabler module in a subsequent communication process.

In still some examples, the security requirement indicates that a security capability that the demander needs to have does not include a security capability that can be provided by the gear, and the demander may trigger unlock of the gear, to send the first information. When the security requirement indicates that the security capability that the demander needs to have does not include the security capability that can be provided by the gear, the demander has ended invoking the gear or does not need to invoke the gear.

In yet some examples, the security requirement indicates that a security capability that the demander needs to have does not include a security capability that can be provided by an enabler module in the gear, and the demander may trigger unlock of the enabler module, to send the first information. When the security requirement indicates that the security capability that the demander needs to have does not include the security capability that can be provided by the enabler module, the demander has ended invoking the enabler module or does not need to invoke the enabler module.

S1302: The gear determines, based on the security requirement, a first parameter used to perform a lock or unlock operation on the gear.

For specific content of S1302, refer to Implementation 3 in S501. For specific content of the first parameter, refer to S1202. Details are not described herein again.

In Implementation b2, the method shown in FIG. 13 includes S1303.

S1303: The demander sends first information including a first parameter to the gear.

For specific content of S1303, refer to Implementation 1 in S501. For specific content of the first parameter, refer to S1202. Details are not described herein again.

After S1302 or S1303, the method shown in FIG. 13 further includes the following steps.

S1304: The gear performs a gear lock or unlock operation.

The gear may lock or unlock the gear based on the first parameter. For specific content, refer to S1205. Details are not described herein again.

S1305: The gear generates first configuration information corresponding to a current configuration. For specific content of the first configuration information, refer to S1205. Details are not described herein again.

S1306: The gear sends fourth information to the engine. The fourth information includes the first configuration information, and the fourth information is used to register the first configuration information.

S1307: The engine verifies whether the first configuration information meets a security policy. If the first configuration information can meet the security policy, the engine may store the first configuration information.

S1308: The engine sends fifth information to the gear. The fifth information indicates whether the first configuration information is successfully registered.

S1309: The gear sends first feedback information to the demander. The first feedback information may include indication information of a first security capability and an ID of the gear.

S1310: The gear stores the first security capability.

For specific content of S1305 to S1310, refer to S1105 to S1110. Details are not described herein again.

According to the procedure shown in FIG. 13, the demander can trigger the lock or unlock of the gear based on the first information, so that the gear can be quickly and flexibly locked or unlocked. In addition, the demander may trigger the lock or unlock of the gear by using signaling. Therefore, when the demander perceives a change in an application scenario, the demander may trigger the lock or unlock of the gear in time, so that the gear can meet a current requirement. In addition, in the method, the demander can trigger the lock or unlock of the gear. This improves a capability of the demander to control the gear serving as a security function, so that the gear can provide a security service for the demander as required. In addition, in the method, the gear may be an entity independent of the demander, the gear may serve as a security function, and the demander may serve as a communication function, so that the security function independent of the communication function can be flexibly locked or unlocked, thereby facilitating independent evolution, update, and upgrade of the security function.

To resolve the foregoing problems, an embodiment of this application provides yet another communication method. The method is a method for deleting a first entity, and is yet another possible implementation of the method shown in FIG. 5. The following describes a procedure of the method in detail by using an example in which a first entity is a gear, a second entity is an engine, and a third entity is a demander.

In this application, a gear deletion method may be a gear deletion method triggered by the engine, a gear deletion method triggered by the demander, or a gear deletion method triggered by the gear. Descriptions are separately provided below.

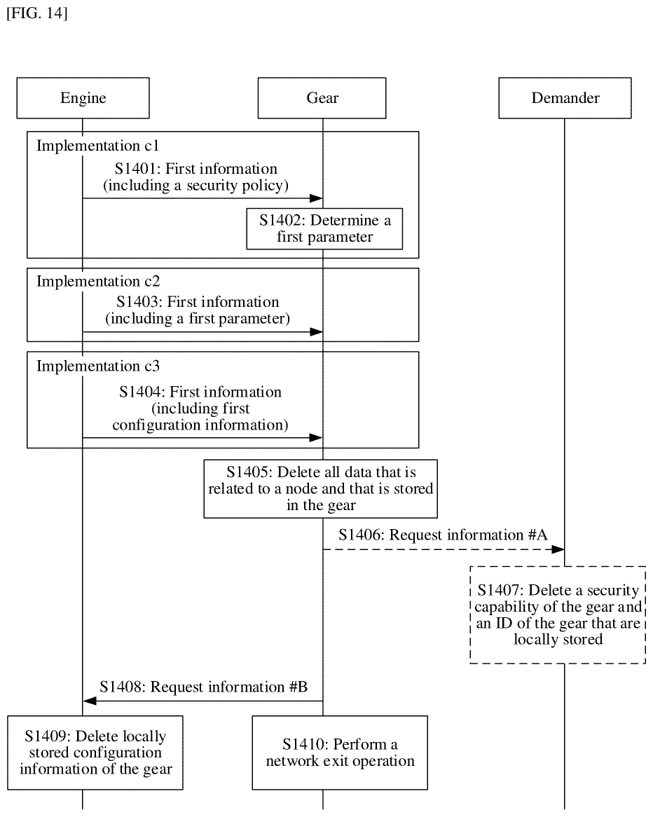

FIG. 14 shows the gear deletion method triggered by the engine. In the method, a fourth entity is the engine. The following describes the method with reference to FIG. 14.

In Implementation c1, the method shown in FIG. 14 includes S1401 and S1402.

S1401: The engine sends first information including a security policy to the gear.

S1402: The gear determines, based on the security policy, a first parameter used to perform a delete operation on the gear.

For specific content of S1401 and S1402, refer to Implementation 2 in S501. Details are not described again.

For example, the first parameter may include: management type=delete, and/or expected state=terminated. This indicates that a type of a management operation performed on the gear is delete, and an expected state of the gear is a terminated state.

In Implementation c2, the method shown in FIG. 14 includes S1403.

S1403: The engine sends first information including a first parameter to the gear.

For specific content of S1403, refer to Implementation 1 in S501. For content of the first parameter, refer to S1402. Details are not described again.

Optionally, after the engine obtains a security policy, or after the engine receives an instruction that is sent by a management plane or another network element and that instructs to delete the gear, the engine may send the first information to the gear. The instruction that instructs to delete the gear may include the first information.

In Implementation c3, the method shown in FIG. 14 includes S1404.

S1404: The engine sends first information including first configuration information to the gear.

For specific content of S1404, refer to Implementation 4 in S501. Details are not described again.

Optionally, in the first configuration information, a state of the gear is a terminated state.

After S1402, S1403, or S1404, the method shown in FIG. 14 further includes:

S1405: After ending running of a currently running program, the gear deletes all data that is related to a node and that is stored in the gear.

S1406: The gear sends request information #A to the demander. The request information #A is used to trigger the demander to delete a security capability of the gear and an ID of the gear that are stored in the demander.

In some possible implementations, the request information #A is a message used to request to delete the security capability and the ID that are of the gear, and the request information #A includes the ID of the gear. In this way, after receiving the request information #A, the demander may determine that the security capability and the ID that are of the gear and that are stored in the demander need to be deleted.

In some other possible implementations, the request information #A may be the second information in S503, and the second information indicates that the first security capability provided by the gear for the demander is an empty set. In this way, after receiving the request information #A, the demander may determine that the security capability and the ID that are of the gear and that are stored in the demander need to be deleted.

S1407: The demander deletes the security capability of the gear and the ID of the gear that are locally stored.

S1406 and S1407 are optional. For example, when the demander has been deregistered or has exited a network, the method shown in FIG. 14 may not include S1406 or S1407.

S1408: The gear sends request information #B to the engine. The request information #B is used to trigger the engine to delete a gear profile of the gear that is stored in the engine.

In some possible implementations, the request information #B is a message used to request to delete the gear profile, and the request information #B includes the ID of the gear. In this way, after receiving the request information #B, the engine may determine that the gear profile of the gear that is stored in the engine needs to be deleted.

In some other possible implementations, the request information #B may be the first feedback information in S502. The first feedback information indicates that the gear is successfully deleted. For example, the first feedback information includes a gear profile #6 of the gear, and in the gear profile #6, the state of the gear is the terminated state. In this way, after receiving the request information #B, the engine may determine that the gear has been deleted, to determine that the gear profile of the gear that is stored in the engine needs to be deleted.

S1409: The engine deletes the locally stored configuration information of the gear (gear profile).

A sequence of performing S1406 and S1407, and S1408 and S1409 is not limited in this application. A sequence of performing S1405 and S1406 to S1409 is not limited in this application.

The method shown in FIG. 14 further includes:

S1410: The gear performs a network exit operation.

Optionally, S1410 is performed after S1405, S1406, and S1408.

According to the method shown in FIG. 14, the engine can trigger the deletion of the gear based on the first information, so that the gear can be quickly and flexibly deleted. In addition, the engine may trigger the deletion of the gear by using signaling. Therefore, when the engine perceives a change in an application scenario, the engine may trigger the deletion of the gear in time, so that the gear can meet a current requirement, and reliable security support is provided for the demander. In addition, in the method, the gear may be an entity independent of the demander, the gear may serve as a security function, and the demander may serve as a communication function, so that the security function independent of the communication function can be flexibly deleted.

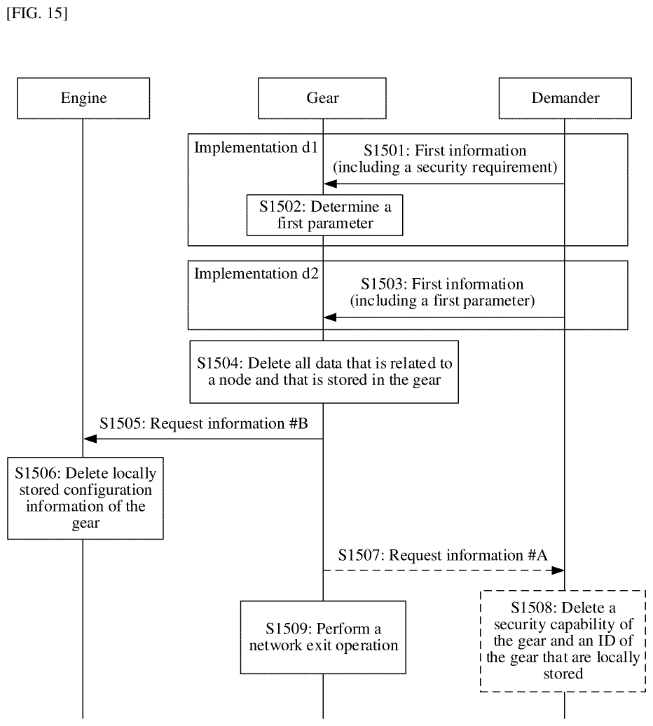

FIG. 15 shows the gear deletion method triggered by the demander. In the method, a fourth entity is the demander. The following describes the method with reference to FIG. 15.

In Implementation d1, the method shown in FIG. 15 includes S1501 to S1503.

S1501: The demander sends first information including a security requirement to the gear.

For specific content of S1501, refer to Implementation 3 in S501. Details are not described again.

For example, when the demander needs to perform an operation such as deregistration or network exit, or the demander needs to use another security authorization other than the gear, the demander determines that the security requirement includes that a security capability provided by the gear is not needed, so that deletion of the gear can be triggered, and the first information is sent to the gear.

S1502: The gear determines, based on the security requirement, a first parameter used to perform a delete operation on the gear.

For specific content of S1502, refer to Implementation 3 in S501. For specific content of the first parameter, refer to S1402. Details are not described herein again.

In Implementation d2, the method shown in FIG. 15 includes S1503.

S1503: The demander sends first information including a first parameter to the gear.

For specific content of S1503, refer to Implementation 1 in S501. For specific content of the first parameter, refer to S1402. Details are not described herein again.

After S1502 or S1503, the method shown in FIG. 15 further includes the following steps.

S1504: After ending running of a currently running program, the gear deletes all data that is related to a node and that is stored in the gear.

S1505: The gear sends a request information #B to the engine. The request information #B is used to trigger the engine to delete a gear profile of the gear that is stored in the engine.

In some possible implementations, the request information #B is a message used to request to delete the gear profile, and the request information #B includes the ID of the gear. In this way, after receiving the request information #B, the engine may determine that the gear profile of the gear that is stored in the engine needs to be deleted.

In some other possible implementations, the request information #B may be the fourth information in S505. For example, the fourth information includes a gear profile #6 of the gear, and in the gear profile #6, a state of the gear is the terminated state. In this way, after receiving the request information #B, the engine may determine that the gear has been deleted, to determine that the gear profile of the gear that is stored in the engine needs to be deleted.

S1506: The engine deletes the locally stored configuration information of the gear (gear profile).

S1507: The gear sends request information #A to the demander. The request information #A is used to trigger the demander to delete a security capability of the gear and an ID of the gear that are stored in the demander.

In some possible implementations, the request information #A is a message used to request to delete the security capability and the ID that are of the gear, and the request information #A includes the ID of the gear. In this way, after receiving the request information #A, the demander may determine that the security capability and the ID that are of the gear and that are stored in the demander need to be deleted.

In some other possible implementations, the request information #A may be the first feedback information in S502, and the first feedback information indicates that the first security capability provided by the gear for the demander is an empty set. In this way, after receiving the request information #A, the demander may determine that the security capability and the ID that are of the gear and that are stored in the demander need to be deleted.

S1508: The demander deletes the security capability of the gear and the ID of the gear that are locally stored.

S1507 and S1508 are optional. For example, when the demander has been deregistered or has exited a network, the method shown in FIG. 15 may not include S1507 or S1508.

A sequence of performing S1505 and S1506, and S1507 and S1508 is not limited in this application. A sequence of performing S1504 and S1505 to S1508 is not limited in this application.

The method shown in FIG. 15 further includes:

S1509: The gear performs a network exit operation.

Optionally, S1509 is performed after S1504, S1505, and S1507.

In some possible implementations, if the demander detects that the bound gear has exited the network, the demander may trigger the deletion of the gear. For example, after detecting that the bound gear has exited the network, the demander may delete the security capability of the gear and the ID of the gear that are locally stored, and send request information #C to the engine, where the request information #C is used to request the engine to delete the gear profile. After receiving the request information #C, the engine may delete the locally stored gear profile of the gear. Optionally, the request information #C may include the ID of the gear.

According to the procedure shown in FIG. 15, the demander can trigger the deletion of the gear based on the first information, so that the gear can be quickly and flexibly deleted. In addition, the demander may trigger the deletion of the gear by using signaling. Therefore, when the demander perceives a change in an application scenario, the demander may trigger the deletion of the gear in time, so that the gear can meet a current requirement. In addition, in the method, the demander can trigger the deletion of the gear. This improves a capability of the demander to control the gear serving as a security function, so that the gear can provide a security service for the demander as required. In addition, in the method, the gear may be an entity independent of the demander, the gear may serve as a security function, and the demander may serve as a communication function, so that the security function independent of the communication function can be flexibly deleted.

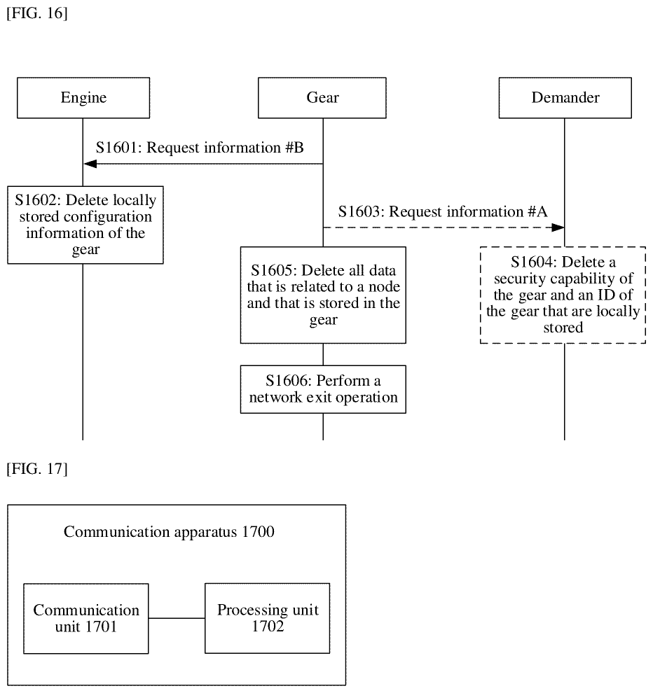

FIG. 16 shows the gear deletion method triggered by the gear. The following describes the method with reference to FIG. 16.

S1601: The gear sends request information #B to the engine, where the request information #B is used to trigger the engine to delete a gear profile of the gear that is stored in the engine.

Optionally, when the gear cannot work due to a program error, or a lifetime in the gear profile of the gear expires, the gear may send the request information #B to the engine.

For specific content of the request information #B, refer to S1408 and S1505. Details are not described herein again.

S1602: The engine deletes the locally stored configuration information of the gear (gear profile).

S1603: The gear sends request information #A to the demander, where the request information #A is used to trigger the demander to delete a security capability of the gear and an ID of the gear that are stored in the demander.

Optionally, when the gear is closed due to a running error, or a lifetime in the gear profile of the gear expires, the gear may send the request information #A to the demander.

For specific content of the request information #A, refer to S1406 and S1507. Details are not described herein again.

S1604: The demander deletes the security capability of the gear and the ID of the gear that are locally stored.

S1603 and S1604 are optional. For example, when the demander has been deregistered or has exited a network, the method shown in FIG. 16 may not include S1603 or S1604.

A sequence of performing S1601 and S1602, and S1603 and S1604 is not limited in this application.

S1605: The gear deletes all data that is related to a node and that is stored in the gear.

A sequence of performing S1601 to S1604 and S1605 is not limited in this application.

The method shown in FIG. 16 further includes:

S1606: The gear performs a network exit operation.

Optionally, S1606 is performed after S1601, S1603, and S1605.

According to the procedure shown in FIG. 16, the gear may trigger the deletion of the gear, so that the gear can be quickly and flexibly deleted. In addition, in the method, the gear may be an entity independent of the demander, the gear may serve as a security function, and the demander may serve as a communication function, so that the security function independent of the communication function can be flexibly deleted.

Based on a same technical concept as the method embodiments in FIG. 5 to FIG. 16, an embodiment of this application provides a communication apparatus shown in FIG. 17, and the communication apparatus may be configured to perform functions of related steps in the foregoing method embodiments. The function may be implemented by hardware, or may be implemented by software or by hardware executing corresponding software. The hardware or the software includes one or more modules corresponding to the function. A structure of the communication apparatus is shown in FIG. 17, and includes a communication unit 1701 and a processing unit 1702. The communication apparatus 1700 may be used in the terminal device, the AN device, the CN device, the engine, or the gear in the communication system shown in FIG. 1, and can implement the communication method provided in the foregoing embodiments and examples of this application. The following describes functions of the units in the communication apparatus 1700.

The communication unit 1701 is configured to receive and send data. In some implementations, the communication unit 1701 may be implemented by using a physical interface, a communication module, a communication interface, and an input/output interface. The communication apparatus 1700 may be connected to a network cable or a cable through the communication unit, to establish a physical connection to another device. In some other implementations, the communication unit 1701 may be implemented by using a transceiver, for example, a mobile communication module. The mobile communication module may include at least one antenna, at least one filter, a switch, a power amplifier, a low noise amplifier (LNA), and the like.

The processing unit 1702 may be configured to support the communication apparatus 1700 in performing a processing action in the foregoing method embodiments. The processing unit 1702 may be implemented by using a processor. For example, the processor may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor or the like.

For a specific function of the processing unit 1702, refer to the descriptions in the communication method provided in the foregoing embodiments and examples of this application. Details are not described herein again.

It should be noted that, in the foregoing embodiment of this application, division into the modules is an example, is merely logical function division, and may be other division during actual implementation. In addition, functional units in embodiments of this application may be integrated into one processing unit, may exist alone physically, or two or more units may be integrated into one unit. The integrated unit may be implemented in a form of hardware, or may be implemented in a form of a software functional unit.

When the integrated unit is implemented in the form of the software functional unit and sold or used as an independent product, the integrated unit may be stored in a computer-readable storage medium. Based on such an understanding, the technical solutions of this application essentially, or the part contributing to a conventional technology, or all or some of the technical solutions may be implemented in form of a software product. The computer software product is stored in a storage medium and includes several instructions for instructing a computer device (which may be a personal computer, a server, a network device) or a processor to perform all or some of the steps of the method described in embodiments of this application. The foregoing storage medium includes any medium that can store program code, such as a USB flash drive, a removable hard disk, a read-only memory (ROM), a random access memory (RAM), a magnetic disk, or an optical disc.

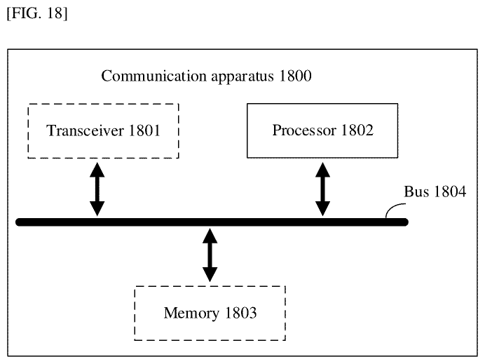

Based on a same technical concept, an embodiment of this application provides a communication apparatus shown in FIG. 18, and the communication apparatus may be configured to perform related steps in the foregoing method embodiments. The communication apparatus may be used in the terminal device, the AN device, the CN device, the engine, or the gear in the communication system shown in FIG. 1, can implement the communication method provided in the foregoing embodiments and examples of this application, and has a function of the communication apparatus shown in FIG. 17. Refer to FIG. 18, the communication apparatus 1800 includes a processor 1802. Optionally, the communication apparatus 1800 further includes a transceiver 1801 and a memory 1803. The transceiver 1801, the processor 1802, and the memory 1803 are connected to each other.

Optionally, the transceiver 1801, the processor 1802, and the memory 1803 are connected to each other through a bus 1804. The bus 1804 may be a peripheral component interconnect (PCI) bus, an extended industry standard architecture (EISA) bus, or the like. The bus may be classified into an address bus, a data bus, a control bus, and the like. For ease of representation, only one bold line is used to represent the bus in FIG. 18, but this does not mean that there is only one bus or only one type of bus.

The transceiver 1801 is configured to receive and send data, to implement communication interaction with another device. For example, the transceiver 1801 may be implemented by using a physical interface, a communication module, a communication interface, and an input/output interface.

The processor 1802 may be configured to support the communication apparatus 1800 in performing a processing action in the foregoing method embodiments. When the communication apparatus 1800 is configured to implement the foregoing method embodiments, the processor 1802 may be further configured to implement the functions of the processing unit 1302. The processor 1802 may be a CPU, or may be another general-purpose processor, a DSP, an ASIC, an FPGA or another programmable logic device, a transistor logic device, a hardware component, or any combination thereof. The general-purpose processor may be a microprocessor or any regular processor or the like.

For a specific function of the processor 1802, refer to the descriptions in the communication method provided in the foregoing embodiments and examples of this application. Details are not described herein again.

The memory 1803 is configured to store program instructions, data, and/or the like. Specifically, the program instructions may include program code, and the program code includes computer operation instructions. The memory 1803 may include a RAM, and may further include a non-volatile memory, for example, at least one disk memory. The processor 1802 executes the program instructions stored in the memory 1803, and uses the data stored in the memory 1803, to implement the foregoing function, to implement the communication method provided in the foregoing embodiments of this application. The memory 1803 may be integrated with the processor 1802, or may be a memory outside the communication apparatus.

It may be understood that the memory 1803 in FIG. 18 of this application may be a volatile memory or a non-volatile memory, or may include both a volatile memory and a non-volatile memory. The non-volatile memory may be a ROM, a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a RAM, and is used as an external cache. By way of example, and not limitation, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM). It should be noted that the memory of the systems and methods described in this specification includes but is not limited to these and any memory of another proper type.

Based on the foregoing embodiments, an embodiment of this application further provides a computer program. When the computer program is run on a computer, the computer is caused to perform the method provided in the foregoing embodiments.

Based on the foregoing embodiments, an embodiment of this application further provides a computer program product including computer-executable instructions. When the computer program product is run, the method provided in the foregoing embodiments is performed.

Based on the foregoing embodiments, an embodiment of this application further provides a computer-readable storage medium. The computer-readable storage medium stores a computer program. When the computer program is executed by a computer, the computer is caused to perform the method provided in the foregoing embodiments.

The storage medium may be any usable medium that can be accessed by the computer. The following provides an example but does not impose a limitation: The computer-readable medium may include a RAM, a ROM, an EEPROM, a CD-ROM, or another optical disc storage or disk storage medium, or another magnetic storage device, or any other medium that can carry or store expected program code in a form of an instruction or a data structure and can be accessed by a computer.

Based on the foregoing embodiments, an embodiment of this application further provides a chip. The chip is configured to read a computer program stored in a memory, to implement the method provided in the foregoing embodiments.

Based on the foregoing embodiments, an embodiment of this application provides a chip system. The chip system includes a processor, configured to support a computer apparatus in implementing functions related to devices in the foregoing embodiments. In a possible design, the chip system further includes a memory, and the memory is configured to store a program and data that are necessary for the computer apparatus. The chip system may include a chip, or may include a chip and another discrete component.

In embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

A person skilled in the art should understand that embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

The computer program instructions may be stored in a computer-readable memory that can indicate the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It is clear that a person skilled in the art can make various modifications and variations to this application without departing from the scope of this application. In this case, this application is intended to cover these modifications and variations of this application provided that they fall within the scope of protection defined by the following claims and their equivalent technologies.

1. A communication method, comprising:
receiving, by a first entity, first information, wherein the first information is used to determine first configuration information of the first entity, and the first configuration information is configuration information used by the first entity to provide a security capability for a third entity; and
sending, by the first entity, first feedback information, wherein the first feedback information indicates whether the first entity is successfully configured with the first configuration information.

2. The method according to claim 1, wherein the first information indicates a first parameter used to perform a management operation on the first entity, and the first parameter is used to determine the first configuration information.

3. The method according to claim 1, wherein the first information indicates a security policy of at least one entity, the at least one entity comprises the third entity, and the security policy is used to determine the first configuration information.

4. The method according to claim 3, wherein the security policy comprises a security capability that the at least one entity needs to have and/or a security capability that the at least one entity does not need to have.

5. The method according to claim 3, wherein the security policy is used to determine a first parameter used to perform a management operation on the first entity, and the first parameter is used to determine the first configuration information.

6. The method according to claim 1, wherein the first information indicates a security requirement of the third entity, and the security requirement is used to determine the first configuration information.

7. The method according to claim 6, wherein the security requirement comprises a security capability that the third entity needs to have and/or a security capability that the third entity does not need to have.

8. The method according to claim 6, wherein the security requirement is used to determine a first parameter used to perform a management operation on the first entity, and the first parameter is used to determine the first configuration information.

9. The method according to claim 2, wherein the management operation comprises one of the following: a setup operation, an update operation, a lock operation, an unlock operation, or a delete operation.

10. A communication method, comprising:
sending, by a fourth entity, first information, wherein the first information is used to determine first configuration information of a first entity, the first configuration information is configuration information used by the first entity to provide a security capability for a third entity, and the fourth entity is the third entity or a second entity that manages the first entity; and
receiving, by the fourth entity, first feedback information, wherein the first feedback information indicates whether the first entity is successfully configured with the first configuration information.

11. The method according to claim 10, wherein the first information indicates a first parameter used to perform a management operation on the first entity, and the first parameter is used to determine the first configuration information.

12. The method according to claim 10, wherein the first information indicates a security policy of at least one entity, the at least one entity comprises the third entity, and the security policy is used to determine the first configuration information.

13. The method according to claim 12, wherein the security policy comprises a security capability that the at least one entity needs to have and/or a security capability that the at least one entity does not need to have.

14. The method according to claim 12, wherein the security policy is used to determine a first parameter used to perform a management operation on the first entity, and the first parameter is used to determine the first configuration information.

15. The method according to claim 10, wherein the first information indicates a security requirement of the third entity, and the security requirement is used to determine the first configuration information.

16. The method according to claim 15, wherein the security requirement comprises a security capability that the third entity needs to have and/or a security capability that the third entity does not need to have.

17. The method according to claim 15, wherein the security requirement is used to determine a first parameter used to perform a management operation on the first entity, and the first parameter is used to determine the first configuration information.

18. The method according to claim 11, wherein the management operation comprises one of the following: a setup operation, an update operation, a lock operation, an unlock operation, or a delete operation.

19. The method according to claim 11, wherein the first parameter comprises at least one of the following:
a type of the management operation performed on the first entity;
a first state, wherein the first state comprises an expected state of the first entity and/or an expected state of a security capability module that is in the first entity and on which the management operation is to be performed;
indication information of a security capability module that is in the first entity and on which the management operation is to be performed; or
indication information of an algorithm that is in a security capability module of the first entity and on which the management operation is to be performed.

20. A communication apparatus, comprising:
a communication unit, configured to receive a first information, wherein the first information is used to determine a first configuration information of the communication apparatus, and the first configuration information is configuration information used to provide a security capability for another communication apparatus,
and send a first feedback information, wherein the first feedback information indicates whether the communication apparatus is successfully configured with the first configuration information.
